(19) United States
(12) Patent Application Publication
(10) Pub. No.: US 2023/0374684 A1
(43) Pub. Date: Nov. 23, 2023

(54) APPARATUS FOR ELECTRO-CHEMICAL EXTRACTION OF ELEMENTAL LEAD FROM DROSS

(71) Applicant: VERDEEN CHEMICALS INC., Bellevue, VA (US)

(72) Inventors: Vipin Tyagi, Bellevue, WA (US); Amol Harishchandra Naik, Mumbai (IN); Nishchay Chadha, Singapore (SG)

(73) Assignee: VERDEEN CHEMICALS INC., Bellevue, WA (US)

(21) Appl. No.: 17/886,924

(22) Filed: Aug. 12, 2022

Related U.S. Application Data
(63) Continuation-in-part of application No. 17/737,869, filed on May 5, 2022.
Application No. 17/737,869 is a continuation-in-part of application No. 17/567,046, filed on Dec. 31, 2021.

(51) Int. Cl. C25C 1/18; C25C 7/06; C25C 7/02

(52) U.S. Cl. CPC C25C 1/18; C25C 7/06; C25C 7/02

(57) ABSTRACT

Disclosed are solutions for the recovery of elemental metals from dross at industrial scales without smelting including, for example, the recovery of near-pure lead from dross resulting from recycled LABs whether by smelting, electrolytic processing, or some other process. Further disclosed are new processes, innovative electrolyzer designs, and/or novel utilization of supplemental chemicals necessary for successful electrolysis of pure metal from impure forms (e.g., pure lead from lead monoxide) found in dross, and especially applicable for solid-state electrolysis of mixtures comprising lead dross paste, electrolyte, and supplemental chemicals. Solid-state electrolysis of mixtures comprising impure lead dross (e.g., dross paste) is made possible by electrolytic processing using supplemental chemicals, and made scalable to industrial levels via utilization of a horizontal cathode in the electrolyzer.

### CROSS-REFERENCE TO RELATED APPLICATION(S)

This application is a continuation-in-part of, claims benefit of and priority to, and incorporates by reference herein in its entirety the following: U.S. patent application Ser. No. 17/737,869, filed May 5, 2022, titled “ELECTROLYTIC EXTRACTION OF ELEMENTAL METAL FROM METAL COMPOUNDS” (Attorney Docket No. AGR2202US1U); which in turn is a continuation-in-part of, and claims benefit of and priority to, U.S. patent application Ser. No. 17/567,046, filed Dec. 31, 2021, titled “ELECTROLYZER WITH HORIZONTAL CATHODE” (Attorney Docket No. AGR2101US1U).

### BACKGROUND

Dross is a mass of solid impurities floating on a molten metal bath that appears when melting certain low-melting-point metals or alloys such as lead, tin, zinc, and aluminum. This dross may comprise oxidized forms of these metals, such as lead monoxide (PbO) on a molten metal bath of pure elemental lead (Pb). Floating solid dross is distinct and separable from the molten elemental form of such metal, that is, dross may be physically removed from the surface of the molten elemental metal bath before the molten elemental metal is poured into a mold (e.g., to produce ingots of pure elemental metal).

During the refining of lead—whether by electrolytic processing, traditional smelting, or other methodology that results in dross—the melting of near-pure elemental lead (Pb) for casting into ingots (or other casting forms) produces dross that is removed from the molten elemental lead to maintain its purity. This dross of solid impure components comprises impurities including lead monoxide (PbO) as well as sodium hydroxide (NaOH), sodium sulfate (Na2SO4), barium sulfate (BaSO4), and carbon (C) which float on the surface of the molten elemental lead. Furthermore, the dross drawn off of the surface of a molten metal bath may also comprise some small portion of elemental lead (Pb) that adheres to the solid components of the dross (like water adhering to the surface of a washed surface).

Notably, elemental lead (Pb) melts at 621.5 degrees F. (327.5 degrees C.) but does not release environmentally harmful fumes below approximately 900 degrees F. (482 degrees C.), thus distinguishing relatively low-temperature environmentally-neutral melting from high-temperature environmentally-unfriendly smelting.

For both environmental and economic reasons, there is a need to further recover from the dross any such elemental lead (Pb) adhering to the dross, as well as recover oxygen-free elemental lead from the lead monoxide (PbO) component of the dross. While traditional tumbling processes are effective at physically recovering the former, the latter lead monoxide (PbO) is still typically recovered by high-heat processes (i.e., re-smelting) to remove the oxygen and recover the elemental lead (Pb). Unfortunately smelting is environmentally unfriendly, energy/heat intensive, and not completely effective at recovering all of the lead, and known electrolytic alternatives (e.g., traditional electrolysis approaches) cannot be scaled up to meet industrial needs.

Accordingly, there is a need in the art and industry for a scalable, cost-effective, and environmentally-friendly solution that would enable the extraction and/or recovery of pure elemental metals from dross including but not limited to the recovery of near-pure elemental lead (Pb) from dross resulting from recycled lead-acid batteries (LABs).

### SUMMARY

Disclosed herein are systems, methods, processes, and/or chemical compositions directed to the recovery of elemental metals at industrial scales without smelting including, for example, the recovery of near-pure lead from dross resulting from recycled LABs via specialized electrolytic processing. The several and various implementations disclosed herein feature new processes, innovative electrolyzer designs, and/or novel utilization of supplemental chemicals necessary for successful electrolysis of pure lead from impure forms of lead dross, and especially applicable for solid-state electrolysis of mixtures comprising lead dross paste, electrolyte, and said supplemental chemicals. With particular regard to recovering near-pure lead from dross resulting from LAB recycling, solid-state electrolysis of mixtures comprising impure lead (e.g., lead dross paste) is made possible by electrolytic processing using supplemental chemicals, and further made scalable to industrial levels via utilization of a horizontal cathode in the electrolyzer.

Accordingly, various implementations disclosed herein are specifically directed to a method and/or system for recovery of near-pure metal from an impure metal-containing dross comprising steps or subsystems for: combining the dross with an electrolyte to form a slurry, said slurry being a mixture of the dross and the electrolyte such that the electrolyte does not dissolve the target metal in the impure metal material; performing electrolysis on the slurry to form target metal deposits and residual components, said electrolysis being performed by an electrolyzer comprising a horizontal cathode having a surface onto which an electrolytic slurry may be emplaced for electrolysis; and separating the target metal in near-pure form from the residual components without smelting. Several such implementations may also further comprise an anode suspended above the horizontal cathode for physically engaging the electrolytic slurry for electrolysis, and/or the addition of at least one supplemental chemical to the slurry prior to performing the electrolysis. Moreover, for several such implementations: the near-pure metal may be elemental lead (Pb) and the dross may comprise at least in part lead monoxide (PbO); the electrolysis may be solid-state electrolysis; the separating may comprise at least in part pressing the target metal; and/or prior to the combining the lead monoxide (PbO) in the dross may be leached into a solution with a solvent.

Select implementations may also be directed to an apparatus for recovery of near-pure metal from an impure metal-containing dross, the apparatus comprising: a horizontal cathode having a surface onto which an electrolytic slurry may be emplaced for electrolysis, the electrolytic slurry comprising the dross combined with an electrolyte to form said slurry, said slurry being a mixture of the dross and the electrolyte such that the electrolyte does not dissolve the target metal in the impure metal material; and an anode suspended above the horizontal cathode for physically engaging the electrolytic slurry for electrolysis. For certain such select implementations: the electrolytic slurry may further comprise at least one supplemental chemical necessary for drawing near-pure metal from the dross; may further comprise a removing mechanism for removing, from the horizontal cathode, an end product resulting from electrolysis; may further comprise a direct current electrical supply and a power controller for controlling a current during electrolysis at one or more levels at one or more time periods during electrolysis; the horizontal anode surface may comprise a plurality of vents through which gaseous compounds resulting from electrolysis can be passed; and/or the near pure metal may be elemental lead (Pb) and the dross may comprise at least in part lead monoxide (PbO).

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1A is a modified block diagram illustrating the major components of an exemplary end-to-end electro-chemical system for reclaiming near-pure lead from LABs—and indicating directional flow of materials between various subsystems thereof—representative of various implementations disclosed herein;

FIG. 1B is a process flow diagram illustrating an exemplary approach for LAB recycling using the system of FIG. 1A representative of the various implementations disclosed herein;

FIG. 1C is a modified process flow diagram of the process shown in FIG. 1B to further illustrate in more detail the separate processing of the other recyclables and dross processing that are representative of the various implementations disclosed herein;

FIG. 2A is an illustration providing a perspective view of an electrolyzer cell 100 representative of various implementations disclosed herein;

FIG. 2B is an illustration providing a blown-out perspective view of the anode and the interior of the electrolyzer cell of FIG. 2A representative of various implementations disclosed herein;

FIG. 3A is an illustration providing a cut-away side view of the electrolyzer cell of FIG. 2A and FIG. 2B, representative of the various implementations disclosed herein, in an initial ready-to-use configuration for conducting electrolysis;

FIG. 3B is an illustration providing a cut-away side view of the electrolyzer cell of FIG. 2A and FIG. 2B, representative of the various implementations disclosed herein, after being filled with electrolytic materials for electrolysis;

FIG. 3C is an illustration providing a cut-away side view of the electrolyzer cell of FIG. 2A and FIG. 2B, representative of the various implementations disclosed herein, after electrolysis has been performed and liquid components have been drained from the electrolyzing compartment;

FIG. 3D is an illustration providing a cut-away side view of the electrolyzer cell of FIG. 2A and FIG. 2B, representative of the various implementations disclosed herein, after the end product of the electrolysis has been scraped from the horizontal cathode surface and removed from the electrolyzing compartment;

FIG. 4A is an illustration providing a perspective view of a vertical stack of electrolyzer cells representative of various implementations disclosed herein;

FIG. 4B is an illustration providing a perspective view of a lateral line comprising multiple stacks of electrolyzer cells representative of various implementations disclosed herein;

FIG. 4C is an illustration providing a perspective view of a parallel array of multiple lateral lines each comprising multiple stacks of electrolyzer cells representative of various implementations disclosed herein;

FIG. 5A is an annotated chemical illustration of the respective molecular structures for lead monoxide (PbO), lead dioxide (PbO2), and lead hydroxide (Pb(OH)2) (collectively the “oxidized lead components” or “lead oxides”);

FIG. 5B is an annotated chemical illustration of the respective molecular structures for lead sulfate (PbSO4) which, for clarity, is shown with bonding charges and without (that is, with the lead (Pb) atom collocated with the two oxygen atoms having a single bond with the sulfur atom);

FIG. 6A is a partial modified block diagram illustrating the major components of an exemplary electro-chemical subsystem, based in part on the system illustrated in FIG. 1A, for cyclically reclaiming near-pure lead from dross representative of various implementations disclosed herein;

FIG. 6B is a partial modified process flow diagram illustrating an exemplary approach for cyclic dross processing, based in part on the approach illustrated in FIG. 1B and FIG. 1C, and utilizing the subsystem illustrated in FIG. 6A, said approach being representative of the various implementations disclosed herein; and

FIG. 6C is a partial modified block diagram illustrating the major components of an exemplary continuous electro-chemical subsystem, based in part on and further extending the system illustrated in FIG. 1A, for the purpose of reclaiming near-pure lead from dross, said subsystem being representative of various implementations disclosed herein;

FIG. 6D is a partial modified block diagram illustrating the major components of an exemplary electro-chemical subsystem, based in part on the system illustrated in FIG. 1A, for continuously reclaiming near-pure lead from lead dross derived from any source, said subsystem representative of various implementations disclosed herein;

FIG. 6E is a partial modified process flow diagram illustrating an exemplary approach for continuous dross processing, based in part on the approach illustrated in FIG. 1B and FIG. 1C, but utilizing the subsystem illustrated in FIG. 6B representative of the various implementations disclosed herein; and

FIG. 7 is a block diagram of an example computing environment that may be used in conjunction with any of the various implementations and aspects herein disclosed.

### DETAILED DESCRIPTION

Elemental metals such as gold, silver, copper, zinc, and lead may be recovered from materials containing these metals by various electrolytic processes (e.g., electrolysis). For example, with regard to recycling lead acid batteries (LABs), the lead paste obtained therefrom (typically comprising portions of pure lead as well as lead monoxide, lead dioxide, and lead sulfate) may be dissolved with or mixed in an electrolyte and the resulting solution or mixture then subjected to electrolytic recovery of pure elemental lead (Pb) at the cathode of an electrolytic device. Similarly, lead dross obtained from such electrolytic processes as well as traditional smelting processes—said lead dross typically comprising portions of pure lead as well as lead monoxide—may be further processed to mechanically remove the pure lead components with the remainder dissolved with or mixed in an electrolyte and the resulting solution or mixture then subjected to electrolytic recovery of pure elemental lead (Pb) at the cathode of an electrolytic device.

However, while conceptually simple and easily implemented on a small scale, the economic recovery of lead from battery paste and its resulting lead dross via electrolytic processes on an industrial scale with sufficient yields and purity and undertaken in an environmentally-friendly manner—as an alternative to existing approaches which require high-temperature smelting—has heretofore been impractical and entirely unachievable. Electrode materials for lead recovery are relatively expensive and operating conditions at the electrodes tend to promote formation of undesirable side products. In existing electrolytic approaches, insoluble lead dioxide frequently forms at the anode, limiting current flow and diminishing operational effectiveness. Likewise, lead produced at the cathode using an acidic electrolyte will deposit as a film on the cathode surface, and this lead can be difficult to remove from the cathode. This deposited lead also re-dissolves into the electrolyte if/when the electric current—that is, the electrical supply performing the electrolysis—is discontinued. Other shortcomings also exist.

Disclosed herein are systems, processes, and chemical compositions for the recovery of elemental metals from dross at industrial scales without smelting, and in particular the recovery of elemental lead from dross resulting from recycled LABs (via electrolytic processing, traditional smelting, or any other methodologies that produce lead-containing dross). Although various implementations disclosed herein may be described as specifically pertaining to the recovery of elemental lead from dross resulting from recycled LABs, such implementations may be equally applied to the recovery of other metals from dross. Accordingly, nothing herein is intended to limit such implementations to lead dross or LAB recycling but, instead, the disclosures made herein should be read as broadly as possible as applied to a variety of different metals being extracted from dross and/or recovered from a variety of potentially different dross sources.

An understanding of various concepts is helpful toward a broader and more complete understanding of the various implementations disclosed herein, and skilled artisans will readily appreciate the implications these various concepts have on the breadth and depth of the various implementations herein disclosed. Certain terms used herein may also be used interchangeably with other terms used herein and such terms should be given the broadest interpretation possible unless explicitly noted otherwise. For example, as used herein the terms electrolysis, electrowinning, and electrorefining should be treated as interchangeable terms such that where one term is used the other terms are also implied, and thus any use of the term electrolysis should be understood to also include electrowinning and electrorefining except where explicitly differentiated. On the other hand, the term “electrolytic processes” is explicitly intended to include and encompass electrolysis, electrowinning, and electrorefining.

Furthermore, as will be readily appreciated and well-understood by skilled artisans, substances that might typically be represented by their chemical compositions using subscripted numbers—such as gaseous oxygen (O₂), water (H₂O), and so forth—may instead be represented herein with regular numbers in lieu of subscripted numbers (i.e., as O2 for gaseous oxygen, H2O for water, and so forth) as the same and equivalent as if subscripted numbers were utilized, and no distinction should be made as to the use of regular numbers versus the use of subscripted numbers anywhere herein.

### Electrolytic Processes

As well-known and readily-appreciated by skilled artisans, electrolysis is a technique that uses an electrical direct current (DC) to drive an otherwise non-spontaneous chemical reaction. Using an electrolytic cell, electrolysis can be used to separate elements from one another. More specifically, in an electrolysis process an electrical current—specifically, a direct current (DC)—is passed through an electrolyte to produce chemical reactions at the electrodes and decomposition of the materials in the electrolyte.

The main components required to achieve electrolysis are an electrolyte, electrodes, and an external power source. The electrolyte is a chemical substance which contains free and mobile ions and is capable of conducting an electric current. An electrolyte may be an ion-conducting polymer, a solution, or an ionic liquid compound. For example, a liquid electrolyte may be produced by “salvation,” that is, by the attraction or association of ions of solute with a solvent (such as water) to produce a mobile cluster of ions and solvent molecules.

To achieve electrolysis, the electrodes (which are properly connected to a power source) are immersed in an electrolyte but separated from each other by a sufficient distance such that a current flows between them through the electrolyte with the electrolyte completing the electrical circuit. In this configuration, the electrical direct current supplied by the power source attracts ions toward the respective oppositely charged electrodes and drives the non-spontaneous reaction.

Each electrode attracts ions that are of the opposite charge: positively charged ions (“cations”) move towards the electron-providing negatively-charged cathode, and negatively charged ions (“anions”) move towards the electron-extracting positively-charged anode. In effect, electrons are introduced at the cathode (as a reactant) and removed at the anode (as the desired end product). The loss of electrons is referred to as oxidation, and the gain of electrons is referred to as reduction.

Cathodes may be made of the same material as anodes but, typically, are instead made from a more reactive material since anode wear is greater due to oxidation at the anode. Anodes may be made of the same material as cathodes; however, oftentimes anodes are instead made from a less reactive material than the cathode because during electrolysis the wear on the anode is generally greater than the wear on the cathode due to oxidation that occurs at the anode.

When neutral atoms or molecules gain or lose electrons—such as those that might be on the surface of an electrode—they become ions and may dissolve in the electrolyte and react with other ions. Conversely, when ions gain or lose electrons and become neutral, they may form compounds that separate from the electrolyte. For example, positive metal ions may deposit onto the cathode in a layer. Additionally, when ions gain or lose electrons without becoming neutral, their electronic charge is nonetheless altered in the process.

The key process of electrolysis is the interchange of atoms and ions via the addition or removal of electrons resulting from the applied electrical direct current to produce the desired end product (or multiple end products as the case may be). The desired end product of electrolysis is often in a different physical state from the electrolyte and may be removed by one of several different physical processes such as, for example, by collecting a gaseous end product from above an electrode, by electrodeposition of the dissolved end product out of the electrolyte, or by removing solid end product buildup at one of the electrodes (e.g., scraping).

Whereas the decomposition potential of an electrolyte is the voltage needed for electrolysis to occur, the quantity of the end product derived from electrolysis is proportional to the electric current applied and, under Faraday's laws of electrolysis, when two or more electrolytic cells are connected in series to the same power source, the end product produced in the cells are proportional to their equivalent weight.

### Solid-State Electrolysis

For “solid-state electrolysis,” a solid metallic compound or a mixture of metallic compounds (“active material”) may be reduced into a pure metal end product via electrolysis by placing the active material in direct contact with the cathode of the electrolytic cell. However, because various active materials are not naturally adhesive, placing active material onto a cathode surface (e.g., “pasting”) can be problematic.

Typically active material is pasted directly onto the cathode by removing the cathode from the electrolyte in the electrolytic cell and applying a mixture of active material and electrolyte onto the cathode surface. After this mixture is allowed to dry on the cathode, the cathode is then again suspended in the electrolyte of the electrolytic cell. However, at an industrial scale of operations, pasting of active material onto cathode surface is time-consuming and expensive due in part to the size of electrodes required for such pasting. Moreover, during electrolysis the dry-pasted active material on the cathode may absorb moisture from the electrolyte in the electrolytic cell, causing the pasted material to slough off or slide away from the cathode, and which also results in water-type electrolysis of this absorbed moisture, that together effectively substitutes for and/or precludes the desired electrolytic reaction of the active material. Additionally, it may be natural for what little end product that results to buildup at and adhere to the cathode itself, and removing this end product from the cathode may be time-consuming, inefficient, and expensive.

It is because of these inherent shortcomings that solid-state electrolysis has not been utilized for processing active materials commercially on an industrial scale, such industries opting instead for more traditional approaches for purifying active material into the desired end products such as smelting. However, as well-known and widely understood by skilled artisans, smelting has its own shortcomings and thus there remains a need for an alternative purifying process and machinery for performing same on an industrial scale.

### Lead Acid Battery Recycling

Lead acid batteries (LABs) are widely used today and, unlike other battery types, are almost entirely recyclable, making lead acid batteries the single most recycled item today. Recycling lead is economically important because LAB production continues to increase globally year over year, yet production of new lead is becoming increasingly difficult due to depletion of lead-rich ore deposits. However, almost all current lead recycling from LABs at industrial scale is based on smelting, a pyro-metallurgical process in which lead, lead oxides (e.g., PbO and PbO2), and other lead compounds are heated to approximately 1600 degrees F. to 2200 degrees F. (900 degrees C. to 1200 degrees C.) and then mixed with various reducing agents to remove oxygen, sulfates, and other non-lead materials. Unfortunately lead smelting is highly polluting due to its generation of significant airborne waste (e.g., lead dust, arsenic, carbon dioxide, and sulfur dioxide), solid waste (e.g., slag that contains hazardous compounds of lead and other heavy metals), and liquid waste (e.g., sulfuric acid, arsenic, and other heavy metals and their oxides). Indeed, the pollution generated from smelting is so high that it has forced the closure of many smelters in the U.S. and other western nations to protect the environment. And although migration and expansion of smelting in less regulated countries has resulted in large scale pollution and high levels of human lead contamination in those countries, similar curtailing measures are expected in those countries as time progresses and new technologies become available.

Although numerous approaches for lead recycling from LABs are known in the art, they all suffer from one or more disadvantages that render them impractical. As such, there remains a need for improved devices and methods for scalable smelterless recycling of LABs that can achieve maximum lead recovery with minimal environmental impact and undue cost. And although some efforts have been made to move away from smelting operations and to use more environmentally friendly solutions, to date all have come up short for various reasons ranging from different pollution problems to low-yields and low-profitability to lab-type solutions that cannot be scaled up effectively or efficiently.

### Electrolytic Processes

As briefly described earlier herein, elemental metals like gold, silver, copper, zinc, and lead may be recovered from materials containing these metals by various electrolytic processes (e.g., electrolysis). For example, with regard to recycling lead acid batteries (LABs), the lead paste obtained therefrom—typically comprising portions of pure lead as well as lead monoxide, lead dioxide, and lead sulfate—may be dissolved with or mixed in an electrolyte and the resulting solution or mixture then subjected to electrolytic recovery of pure elemental lead (Pb) at the cathode of an electrolytic device.

However, while conceptually simple and easily implemented on a small scale, the economic recovery of lead from battery paste via electrolytic processes on an industrial scale with sufficient yields and purity and undertaken in an environmentally-friendly manner—as an alternative to existing approaches which require high-temperature smelting—has heretofore been impractical and entirely unachievable. Electrode materials for lead recovery are relatively expensive and operating conditions at the electrodes tend to promote formation of undesirable side products. In existing electrolytic approaches, insoluble lead dioxide frequently forms at the anode, limiting current flow and diminishing operational effectiveness. Likewise, lead produced at the cathode using an acidic electrolyte will deposit as a film on the cathode surface, and this lead can be difficult to remove from the cathode. This deposited lead also re-dissolves into the electrolyte if/when the electric current—that is, the electrical supply performing the electrolysis—is discontinued. Other shortcomings also exist.

Accordingly, there is a long-felt need in the art and industry for scalable, cost-effective, and environmentally-friendly solutions that would enable the extraction and/or recovery of pure elemental metals from impure sources, for example, recovering near-pure lead (Pb) during LAB recycling.

As used herein (both heretofore and hereafter), the term “near-pure” shall mean a purity comparable to within 90% of the average purity obtainable by traditional smelting processes. Likewise, the term “pure” shall mean a purity that is equal to or exceeds the typical purity level obtainable by traditional smelting processes, and the term “perfect purity” shall mean a purity that is 99.000% comprised of the elemental metal without regard to natural surface oxidation or hydroxidation. Accordingly, for all implementations disclosed herein for obtaining “near-pure” metal, such disclosures should be deemed to also disclose alternative implementations for obtaining “pure” and “perfectly pure” metals as well. Also as used herein, the term “recovery” and other equivalent terms (e.g., purification, derivation, etc.) shall refer to the obtaining of a purer metal (e.g., elemental lead) from a less pure form of said metal (e.g., lead oxides) via electrolysis or other electrolytic processes.

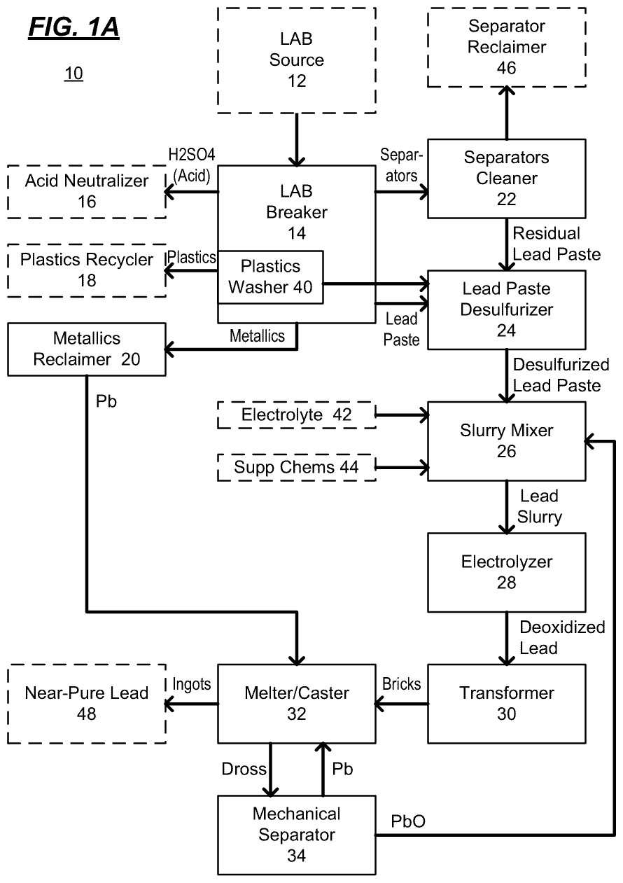

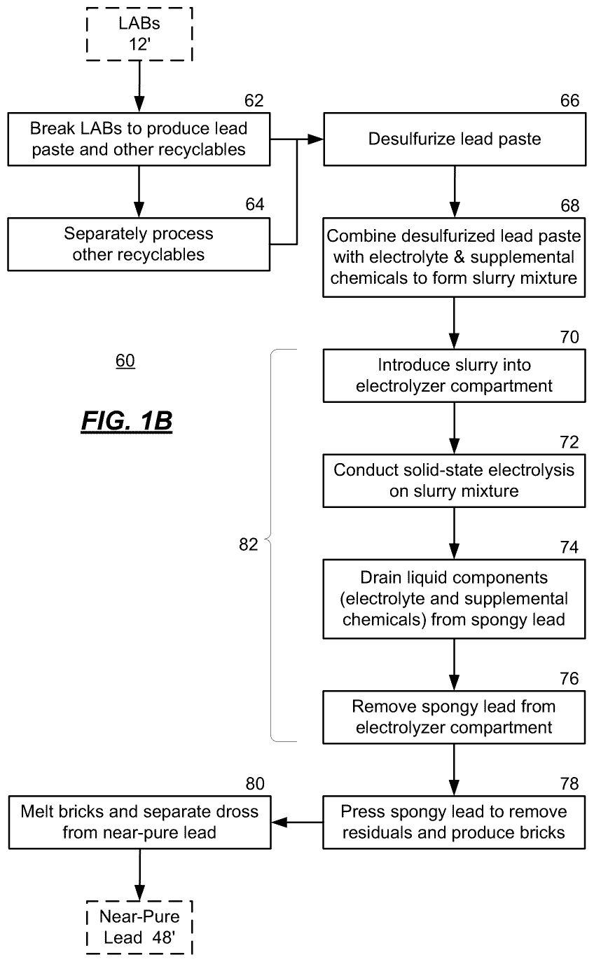

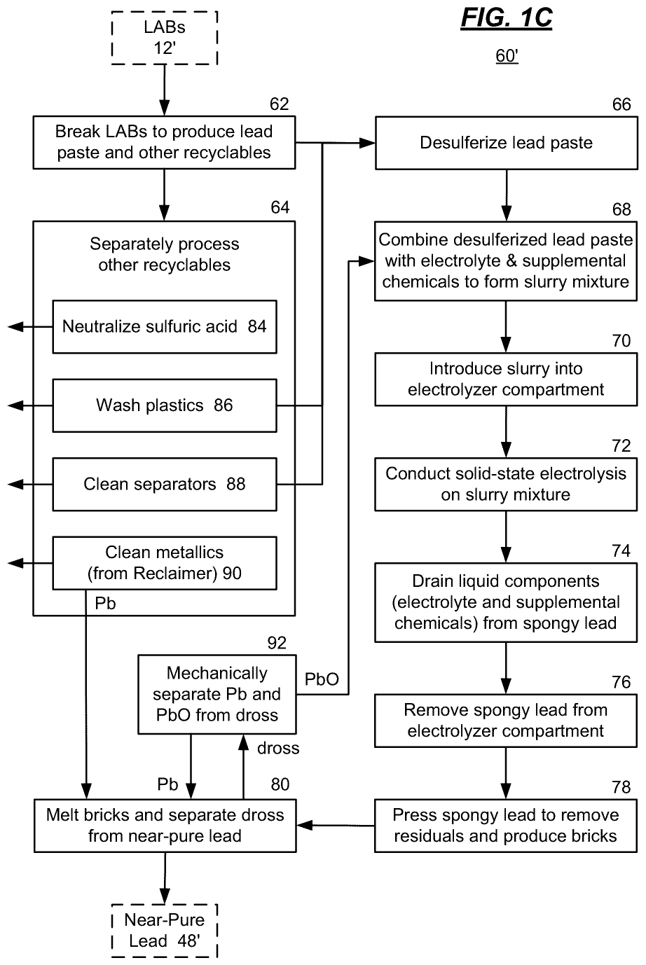

FIG. 1A is a modified block diagram 10 illustrating the major components of an exemplary end-to-end electro-chemical system for reclaiming near-pure lead from LABs—and indicating directional flow of materials between various subsystems thereof—representative of various implementations disclosed herein.

In FIG. 1A, LABs designated for recycling may be provided by an LAB source 12 (shown using dotted lines to indicate an input or output with regard to the system) to the LAB breaker 14 where the LABs may be physically reduced and divided into five main components: battery acid (when present), plastics, metallics, separators, and lead paste. The battery acid, which is typically sulfuric acid (H2SO4), may then be outputted to an acid neutralizer 16 for further processing, although this operation may not be necessary (and thus optional) when the LABs provided by the LAB source 12 have already had the battery acid removed or the acid is not otherwise present. The LAB breaker may also comprise a plastics washer 40 for removing lead residue (typically lead monoxide) adhering to the surface of the plastics before outputting the lead-free (or near-lead-free) plastics to a plastics recycler 18.

The metallics broken apart by the LAB breaker 14 may be sent to a metallics reclaimer 20 to reclaim the lead components thereof—typically pure lead (Pb)—and convey the reclaimed lead to a melter/caster 32 (described below) while properly outputting (e.g., disposing of or further recycling) the remaining non-lead metallics. Likewise, the separators broken apart by the LAB breaker 14 may be conveyed to the separator cleaner 22 to recover residual lead therefrom which, along with the lead paste derived from LAB breaking by the LAB breaker 14 (either directly and/or from the plastics washer 40), are conveyed to the lead paste desulfurizer 24 with the remaining non-lead separator components output to the separator reclaimer 46.

The lead received by the lead paste desulfurizer 24 directly from the LAB breaking in the LAB breaker 14, from the plastics washer 40 thereof, and/or from the separator cleaner 22 typically comprises elemental lead (Pb), lead monoxide (PbO), and lead dioxide (PbO2), as well as lead sulfate (PbSO4). The lead paste desulfurizer 24 treats the lead paste to remove the sulfur from the lead sulfate (PbSO4), sulfur being a highly-damaging environmental pollutant. This desulfurization may be accomplished by the introduction of sodium hydroxide (NaOH) into the lead paste to chemically transform the lead sulfate (PbSO4) into lead hydroxide (Pb(OH)2) and the sodium hydroxide (NaOH) into sodium sulfate (Na2SO4), the sodium sulfate (Na2SO4) then being removed from the paste by the lead paste desulfurizer 24 utilizing any of various means known and appreciated by skilled artisans. In addition, barium sulfate (BaSO4) may also be added to the lead paste prior to or during the desulfurization process as an additive where the barium sulfate, which does not react with the sodium hydroxide (NaOH) during desulfurization, and is intentionally retained in the resultant (and otherwise “desulfurized”) lead paste in anticipation of being later removed by subsequent subsystems. As such, the desulfurization accomplished by the lead paste desulfurizer 24 intentionally removes only the sulfur from the lead sulfate (PbSO4). Regardless, the desulfurized lead paste—now comprising metallic lead only in the forms of elemental lead (Pb), lead monoxide (PbO), lead dioxide (PbO2), and lead hydroxide (Pb(OH)2)—may then be passed to the slurry mixer 26 where the desulfurized lead paste is combined with an electrolyte 42 and supplemental chemicals 44 (discussed in more detail later herein) to form a lead slurry solution or mixture.

Notably, for certain alternative implementations of the system 10, the plastics, metallics, separators, and lead paste may be provided to the system 10 directly and/or separately, already in broken form, by one or more input sources (not shown) in lieu of the LAB source 12, in which case such inputs may bypass the LAB breaker 14 and proceed to the appropriate other subsystem(s) accordingly. Likewise, for certain other alternative implementations, lead paste may instead be provided directly to the system, that is, either to the lead paste desulfurizer 24 if not yet desulfurized, or to the slurry mixer 26 if already desulfurized (with specific regard to the lead sulfate (PbSO4) but not to the barium sulfate (BaSO4) as explained above).

At the slurry mixer 26, and for several such implementations herein disclosed, sodium hydroxide (NaOH) may also be used as the electrolyte for subsequent electrolytic processing (e.g., electrolysis) of the lead paste, in which case the resultant lead slurry would be a mixture of the desulfurized lead paste and the electrolyte (and not a solution thereof in the chemical sense). The lead slurry is then transferred from the slurry mixer 26 to the electrolyzer 28 for electrolytic processing (described in more detail later herein). The electrolyzer 28 operates to produce substantially deoxidized elemental lead (Pb) from the lead monoxide (PbO), lead dioxide (PbO2), and lead hydroxide (Pb(OH)2) found in the lead slurry.

For certain other alternative implementations of the system 10, instead of desulfurizing the impure metal material prior to combining the impure metal material with the electrolyte to form the slurry, sulfur-containing impure metal material may be combined with the electrolyte to form a sulfur-containing slurry, and the electrolyzer itself may be utilized to desulfurize the impure metal material prior to or during the aforementioned electrolysis. For example, this additional functionality for the electrolyzer may be achieved through the consumption of stoichiometric caustic included in the electrolyte and causing in situ generation of sodium sulfate which is separable from the resultant deoxided lead in subsequent processing.

Regardless, the resultant deoxidized lead then may be transferred to the transformer 30 for transformation into solid bricks having minimal amounts of the electrolyte and/or the supplemental chemicals. For lead slurry mixtures (but not solutions), much of the electrolyte and/or supplemental chemicals may be drawn off by the electrolyzer 28 before being transferred to the transformer 30, and/or the transformer may comprise physical pressing of the deoxidized lead into solid bricks, said pressing also being effective in removing much of the residual electrolyte and/or supplemental chemicals. For lead slurry solutions, on the other hand, the transformer 30 might instead precipitate the deoxidized lead and thereby separate it from the electrolyte and supplemental chemicals before then pressing it into bricks.

The lead bricks—which may still have some minimal amount of electrolyte, supplemental chemicals and other impurities including but not limited to barium sulfate (BaSO4), oxidized lead (lead monoxide, lead dioxide, and/or lead hydroxide), as well as any new natural oxidation occurring on the surface of the bricks—are then sent to the melter/caster 32 for melting down, drawing off dross, and casting as output ingots of near-pure lead 48. This melting and casting may also include as input the lead reclaimed by the metallics reclaimer 20 described earlier herein. The dross, on the other hand, may be passed to a mechanical separator 34 to separate elemental lead (Pb) for subsequent return to the melter/caster 32, and lead monoxide (PbO)—along with other impurities together forming lead dross—for return to the slurry mixer 26 and inclusion in the next mix of lead slurry for subsequent processing (disclosed in greater detail later herein). Separately, for select implementations the barium sulfate (BaSO4), electrolyte, and supplemental chemicals (and remnants thereof) may be recovered at various points in the system and/or reused (not shown).

Typically dross is physically skimmed to the rim of the melting container (sometimes referred to as a “kettle” or “pot”) and manually or mechanically shoveled (or “spooned”) into a separate container. Historically dross was manually removed from large kettles by two people, one using a pusher to push dross across the surface of the molten metal bath to another equipped with a perforated spoon which was manipulated to scoop up the dross and, after allowing molten lead to drain back into the kettle through the perforations in said spoon, to discharge the dross into a separate dross container. More processes fundamentally replicate this historical methodology using manual, mechanical, or a combination of manual/mechanical means that are well-known and readily-appreciated to skilled artisans, as are other mechanical dross-removal methods such as “vacuum drossing” and other non-traditional approaches.

FIG. 1B is a process flow diagram 60 illustrating an exemplary approach for LAB recycling using the system of FIG. 1A representative of the various implementations disclosed herein. In FIG. 1B, at 62 LABs received for recycling may be broken to produce lead paste and other recyclable, the latter of which may be separately processed at 64 as generally described earlier herein with regard to FIG. 1A. Any additional lead recovered from this separate processing may be returned and combined with the lead paste directly resulting from the breaking at 62.

At 66 the lead paste derived at 62 (and 64 if any) may then be desulfurized—such as by treating with sodium hydroxide (NaOH), potassium hydroxide (KOH), ammonium hydroxide (NH4OH) or aqueous solution of ammonia, or other suitable chemicals—such that the resulting desulfurized lead paste substantially comprises sulfur-free lead components, e.g., Pb, PbO, PbO2, and Pb(OH)2) but no lead sulfate (PbSO4). At 68 the desulfurized lead paste may be combined with an electrolyte and supplemental chemicals to form a slurry mixture (or, in alternative implementations, a slurry solution). At 70, this slurry is then introduced into an electrolyzer cell and, at 72, solid-state electrolysis (or, in alternative implementations, typical solution-based electrolysis) may be performed.

Once electrolysis is complete, at 74 the liquid components (which may include supplemental chemicals or remnants thereof) may then be drained first and, at 76, the remaining solid components resulting from the electrolysis—which may be in the form of “spongy lead” solids permeated with residual liquid components—may also be removed, or in alternative implementations the liquid components and solid components may be removed from the electrolyzer simultaneously. At 78 the “spongy lead” solid components—which now substantially comprise pure lead (Pb)—may be pressed to remove nearly all remaining liquid components (“residuals”) and form substantially pure lead bricks. At 80 the lead bricks may then be melted to eliminate nearly all remaining trace amounts of non-lead components and other minor impurities—said melting occurring (at temperatures far below those required for smelting—to further purify the lead bricks and form near-pure lead ingots for output.

Notably, elements 70-76 of FIG. 1B—denoted as the electrolytic process group 82 in the figure—are performed utilizing the various implementations of an electrolytic cell described in greater detail below, although nothing herein limits utilization of such implementations to lead recycling or to just this portion of a lead recycling process; on the contrary, other additional utilizations of such implementations are also anticipated by such implementations. For example, various implementations disclosed herein may be used to further process the dross removed during the melting 80 including but not limited to the processing described with regard to FIG. 1A above.

FIG. 1C is a modified process flow diagram 60′ of the process 60 shown in FIG. 1B to further illustrate in more detail the separate processing of the other recyclables 64 and dross processing 92 that are representative of the various implementations disclosed herein. In FIG. 1C, at 84 the battery acid—which is typically sulfuric acid (H2SO4)—is neutralized and outputted from the system. At 86 the plastics are washed and outputted from the system with any lead residue (typically lead monoxide) recovered from the surface of the plastics being combined with the lead paste to be desulfurized. Likewise, at 88 the separators are also washed and outputted from the system with any lead residue (typically lead monoxide) recovered from the surface of the plastics being combined with the lead paste to be desulfurized. And at 90 the metallics are cleaned (or “reclaimed”) with non-lead metallics outputted (discarded or recycled) and the lead components thereof—typically pure lead (Pb)—conveyed directly to the melter for melting at 80. However, it should be noted that often the metallics recovered from an LAB comprise both lead (Pb) and antimony (Sb) as an alloy—that is, as lead antimony (or antimonial lead)—where the lead and antimony need not be separated, for which certain alternative implementations may instead output lead antimony from the reclaimer 90 for melting at 80 and forming near-pure antimonial lead instead of near-pure elemental lead (Pb).

Also shown in FIG. 1C is how the dross that results from the melting at 80 can be mechanically separated, at 92, with the lead monoxide (PbO) resulting from the mechanical separation being added, directly or indirectly, to a subsequent batch of desulfurized lead paste at 68 for re-processing, while elemental lead (Pb) resulting from the mechanical separation is added back into a subsequent batch of spongy lead being melted at 80 (disclosed in greater detail later herein).

### Electrolyzer Cell with Horizontal Cathode

Disclosed herein is an electrolyzer cell comprising a horizontal cathode over which a horizontal anode is suspended. The horizontal cathode may form the base of an electrolyzer compartment into which a mixture of active material and electrolyte—in the form of a slurry, for example—may be introduced, held, and processed. The horizontal anode may be suspended above the cathode in the upper portion of the electrolyzer compartment in such a manner that the anode would physically engage the upper surface of the mixture of active material and electrolyte being held by the electrolyzer compartment while the cathode would naturally engage the bottom surface of the mixture of active material being held in the electrolyzer compartment. The anode may also comprise small openings in the form of vents, trenches, holes, or the like (which may be referred to herein simply as “breathing holes”) across the surface of the anode in order to allow gaseous oxygen (O2) and/or other gaseous substances resulting from the electrolysis to harmlessly escape (instead of being trapped under said anode and creating current resistance).

Accordingly, various implementations disclosed herein may be directed to and/or make use of an electrolyzer comprising a horizontal cathode located below a suspended anode for purposes of performing electrolysis on metal-bearing mixtures or solutions. For several such implementations, the horizontal cathode may comprise the bottom surface of a compartment for containing a mixture or solution of metal components, electrolyte, and/or supplemental chemicals; a horizontal anode for engaging the upper surface of the mixture or solution in the compartment; a gate corresponding to one sidewall of the compartment for facilitating removal of the end-products from the mixture or solution; and/or a removal mechanism for facilitating removal of the end-products of the mixture or solution from the compartment (and the surface of the horizontal cathode) through the gate. Certain implementations disclosed herein are specifically directed to use in recycling of lead acid batteries (LABs) without smelting, although nothing herein is intended to limit the various implementations solely to LAB recycling or lead recovery and, instead, the various implementations disclosed herein may be applied to a variety of different electrolysis operations.

For these various implementations—and in combination with use of additional supplemental chemicals added to the slurry mixture of active material and electrolyte (discussed further below)—an electrical DC current may then be passed from the cathode to the anode through the mixture of active material and electrolyte to produce the desired end product and cause that desired end product to settle on the surface of the cathode. (For certain such implementations, the end product may be pure lead in a spongy form that retains some of the electrolyte and/or supplemental chemicals.) More specifically, the electrical DC current would effectively cause the reduction of metal ions in the active material to disassociate from their counter ion—such as oxide and hydrogen ions which in turn may form water (H2O) and gaseous oxygen (O2)—and the metal, now in its pure form, would then be drawn to and settle upon the horizontal cathode surface due in part to gravity (the metal being heavier than other components in the slurry) and aided in part by the natural ionic convection that occurs in the mixture during electrolysis.

Once the electrolysis is complete, and for several such implementations herein disclosed, the electrolyzer compartment may further comprise an openable side for removing the electrolyte (including the supplemental chemicals and the additional H2O produced during the electrolysis) as well as the end-product metal. Initially this openable side may be only partially opened in order to first permit the purely liquid components—i.e., much of the remaining electrolyte, supplemental chemicals, and the additional water (H2O) produced during the electrolysis—to exit the electrolyzer compartment and, for certain implementations, be channeled away via a small channeling gutter at the base of the openable side. In some implementations, this channeling gutter may then be moved to a storage position away from the openable side (e.g., to below the electrolyzer compartment) after the liquid components have been drained through the openable side of the electrolyzer compartment.

After the liquid components have been drained away—or, in alternative implementations, without first draining the liquid components separately—the openable side may be fully opened to permit the more solid components—namely the end-product metal plus any residual liquid components adhering thereto—to be physically removed from the electrolyzer compartment. For select implementations, the removal may be performed by a vertically-oriented scraping mechanism extending across the width of the electrolyzer compartment and originating on the side opposite the openable side, said scraping component physically contacting and gently scraping the entire cathode surface and adjoining sides of the electrolyzer compartment but operating just below (and without physically contacting) the anode surface. In this manner, the scraping mechanism may operate to push the more solid components out of the electrolyzer compartment and into a collecting receptacle or onto a conveying mechanism (e.g., a conveyor belt) for further processing.

In this manner, the various implementations disclosed herein may overcome the shortcomings in existing approaches to solid-state electrolysis described above as follows: (1) there would be no need to dry-paste the active material to the cathode, saving time and effort; (2) the build-up of absorbed water by the dry-pasted active material during electrolysis—and the interference with the production of the desired end product that results—could be avoided altogether; and/or (3) the buildup of the end product at the cathode would be easier to remove as the flat surface of the cathode facilitates the scraping action (described above) and the supplemental chemicals may help prevent solidification of the end product or adhesion of the end product to the cathode.

Furthermore, for various implementations disclosed herein, multiple electrolyzer cells of the type described herein can be stacked vertically, with appropriate spacing between each electrolyzer cell, which might share a single vertical drop space for the end product pushed out of the multiple electrolyzer cells in a single collecting receptacle or onto a single conveying mechanism. Additionally, several vertical stacks comprising multiple electrolyzer cells can be arranged in a row and further share a single elongated collecting receptacle or a single elongated conveying mechanism. Moreover, multiple rows of vertical stacks can also be arranged with the produced end product being consolidated for continued processing.

Notably, separate from the disclosures made herein, Applicant has discovered that achieving the electrolytic effects described herein are dependent upon the utilization of certain specific chemicals mixed into the slurry along with the electrolyte and active materials. Although the present application is not directed to the composition of any of the these discovered chemicals, the various implementations disclosed herein are in no way limited to the use of any specific chemical additives regardless of whether secret or proprietary (or widely-used and well-known for that matter).

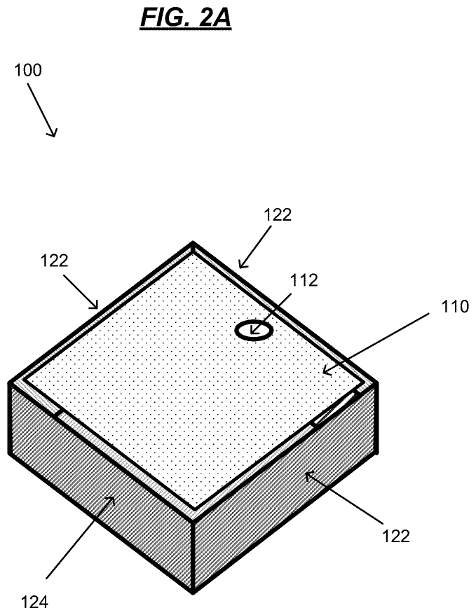

FIG. 2A is an illustration providing a perspective view of an electrolyzer cell 100 representative of various implementations disclosed herein. FIG. 2B is an illustration providing a blown-out perspective view of the anode 110 and the interior of the electrolyzer cell 100 of FIG. 2A representative of various implementations disclosed herein. For convenience, FIG. 2A and FIG. 2B may be referred to herein collectively as FIG. 2.

As illustrated in FIG. 2, an electrolyzer cell 100 may comprise an anode 110 suspended above a horizontal cathode 120 at a distance suitable for performing electrolysis. The electrolyzer cell 100 may also comprise vertical containing surfaces 122 and at least one gate 124 that, together with the horizontal cathode 120, form and provide an electrolyzer compartment 126 into which a mixture of active material and electrolyte—in the form of a slurry, for example—may be introduced, held, and processed. The vertical containing surfaces 122 and the gate 124—or at least the internal surfaces thereof relative to contents of the electrolyzer compartment 126—may be electrically non-conductive.

As shown, the anode 110 may be configured as a horizontal anode, although other forms of anode may also be utilized such as, for example, a series of anode rods, strips, grids, or other structures that could physically engage the upper surface of an electrolytic slurry emplaced onto the cathode. Regardless, the anode 110 may be suspended above the cathode 120 in the upper portion of the electrolyzer compartment 126 in such a manner that the anode would physically engage the upper surface of the mixture of active material and electrolyte being held by the electrolyzer compartment while the cathode would naturally engage the bottom surface of the active material mixture being held in the electrolyzer compartment. For those implementations featuring a horizontal anode, the anode 110 may also comprise small openings or vents 114 (i.e., “breathing holes”) across its surface to allow gaseous oxygen (O2) resulting from electrolysis to harmlessly escape (instead of building up under said anode). The anode 110 may also comprise an opening 112 through which the electrolytic slurry may be emplaced into the electrolyzer compartment and onto the horizontal cathode 120 in sufficient quantity for an upper surface of said electrolytic slurry to simultaneously physically engage the suspended anode 110 and thereby complete the circuit for a current running between the cathode 120 and anode 110 for purposes of electrolysis.

The electrolyzer cell 100 may further comprise a removing mechanism 160. For various implementations, this removing mechanism 160 may comprise a vertically-oriented surface extending across the width of the electrolyzer compartment 126 and originating on the side opposite the gate 124, said surface being capable of physically contacting and gently scraping the entire cathode 120 surface and adjoining sides of the electrolyzer compartment 126 and operating below the anode 110 surface. The removing mechanism—or at least the portions thereof exposed to the contents of the electrolyzer compartment 126—may be electrically non-conductive.

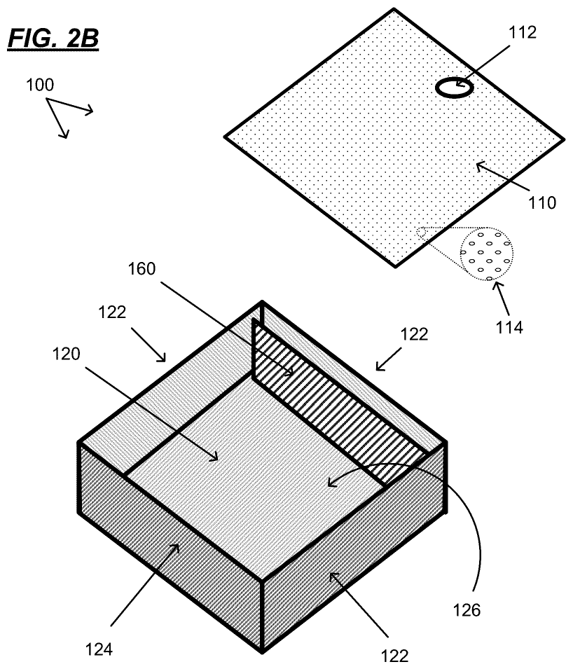

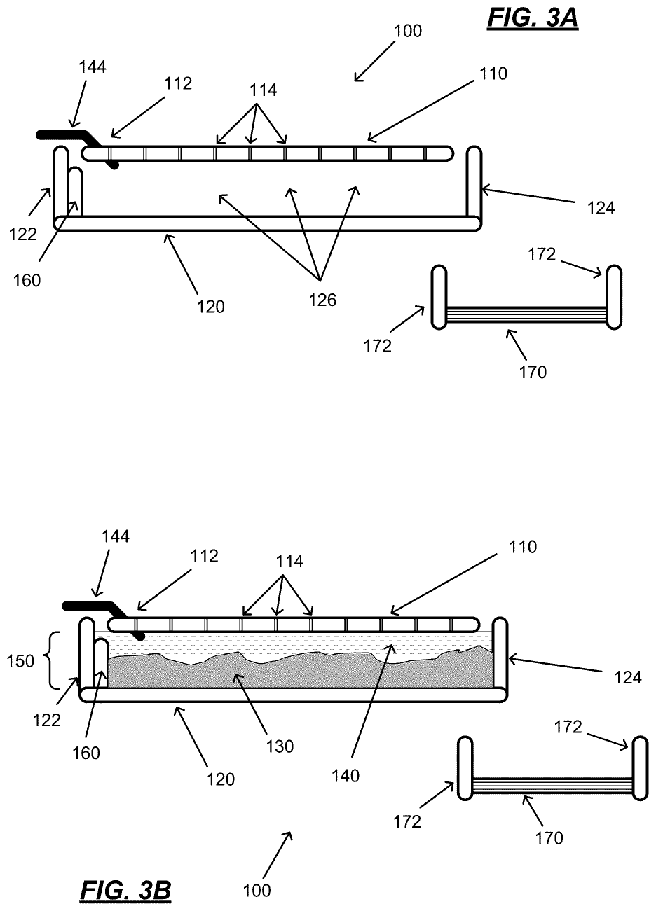

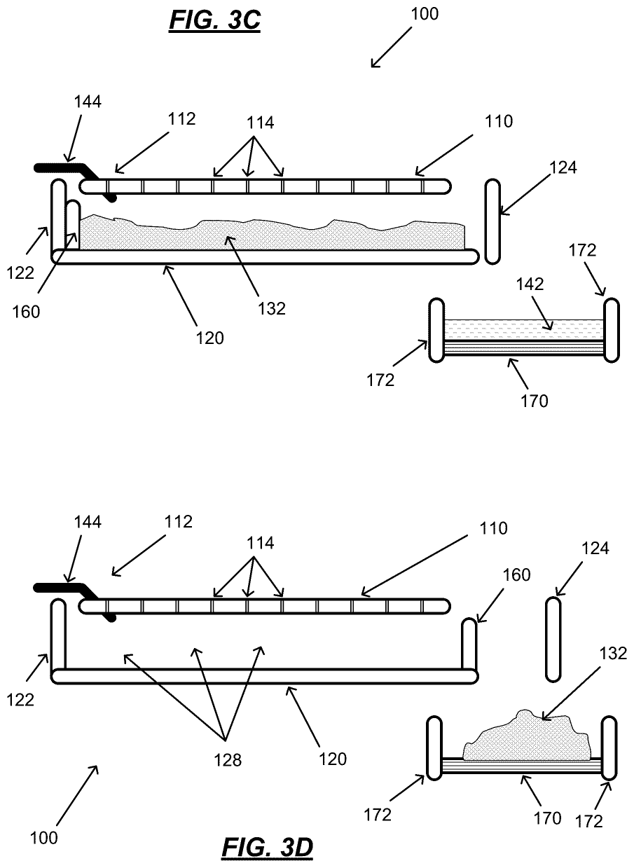

FIG. 3A is an illustration providing a cut-away side view of the electrolyzer cell 100 of FIG. 2A and FIG. 2B, representative of the various implementations disclosed herein, in an initial ready-to-use configuration for conducting electrolysis. As illustrated in FIG. 3A, the electrolyzer compartment 126 is empty but ready to be filled, with the removal mechanism 160 in a set position and with the gate 124 closed. In this configuration, an electrolytic slurry may then be emplaced into the electrolyzer compartment 126 and onto the horizontal cathode 120 via a slurry line 144 extending through the opening 112 in the anode 110. Also shown in FIG. 3A is a conveyor belt 170 comprising containing sides 172 and disposed beneath the gate 124 as a conveying mechanism for use during removal of the contents of the electrolyzer compartment 126 after electrolysis is complete.

FIG. 3B is an illustration providing a cut-away side view of the electrolyzer cell 100 of FIG. 2A and FIG. 2B (as well as FIG. 3A), representative of the various implementations disclosed herein, after being filled with electrolytic materials 150 for electrolysis. As illustrated in FIG. 3B, the electrolytic materials 150 comprise a mixture of active materials 130 and electrolyte 140 as well as supplemental chemicals interspersed therein. The bottom surface of the electrolytic materials 150 physically engages (i.e., is in physical contact with) the horizontal cathode 120 while the upper surface of the electrolytic materials (specifically, the electrolyte component thereof) physically engages the anode 110. (For various implementations, sufficient electrolyte may be included in the electrolytic materials to form the upper surface of the electrolytic materials in order to prevent solid material contact from developing between the cathode and anode which might create an electrical short and prevent the cathode plate from reducing lead ions from the compounds.) An electric current can then be applied to the electrolytic materials 150 via the anode 110 and cathode 120, with the electrical circuit being completed by the mobile ions in electrolyte 140, and with electrolysis taking place in said electrolytic materials 150 accordingly.

FIG. 3C is an illustration providing a cut-away side view of the electrolyzer cell 100 of FIG. 2A and FIG. 2B (as well as FIG. 3A and FIG. 3B), representative of the various implementations disclosed herein, after electrolysis has been performed and liquid components 142 have been drained from the electrolyzing compartment 126 by opening the gate 124 into a first position that provides sufficient space through which said liquid components can pass from the electrolyzer compartment 126 onto the conveyor belt 170 for recovery of said liquid components. Meanwhile the desired end product 132 of the electrolysis remains on the horizontal cathode 120 awaiting its own removal from the electrolyzer compartment 126.

FIG. 3D is an illustration providing a cut-away side view of the electrolyzer cell 100 of FIG. 2A and FIG. 2B (as well as FIG. 3A, FIG. 3B, and FIG. 3C), representative of the various implementations disclosed herein, after the end product 132 resulting from the electrolysis has been removed from the horizontal cathode 120 surface and from the electrolyzing compartment. As shown in FIG. 3D, the gate 124 has moved to a second fully-open position and the removal mechanism 160 has traversed the interior of the electrolyzer cell 100 and removed the end product 132 from the electrolyzer cell 100 and onto the conveyor belt 170. With the removal mechanism 160 in this deployed position and the gate 124 fully open as shown, the empty interior of the electrolyzer cell 128 is no longer an electrolyzing compartment 126 but will again become an electrolyzing compartment 126 after the removal mechanism 160 is returned to its original position and the gate 124 is closed (as shown in FIG. 3A for example). For convenience, FIG. 3A, FIG. 3B, FIG. 3C, and FIG. 3D may be collectively referred to herein as FIG. 3.

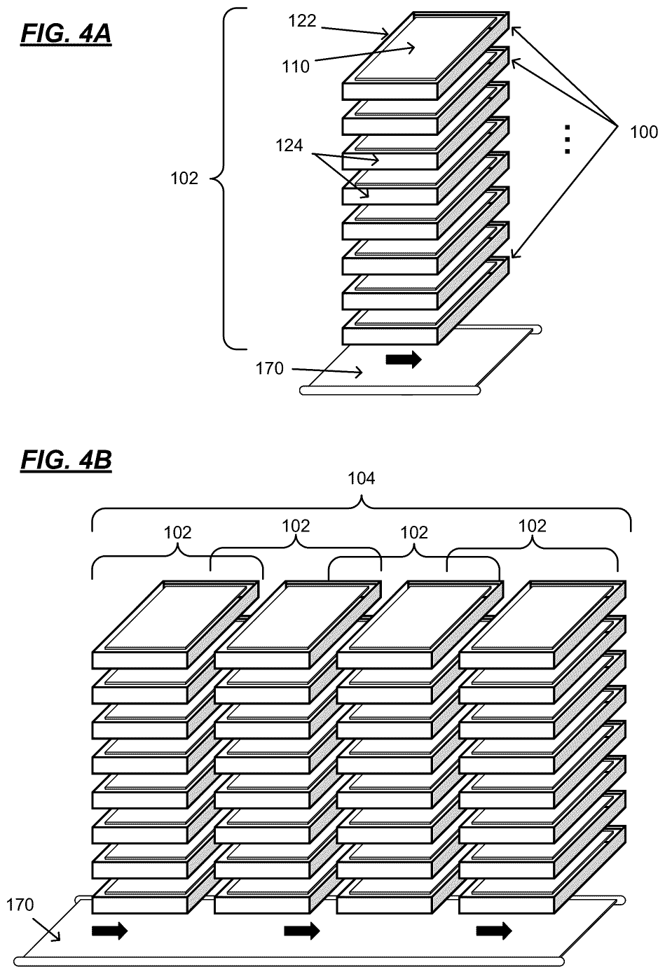

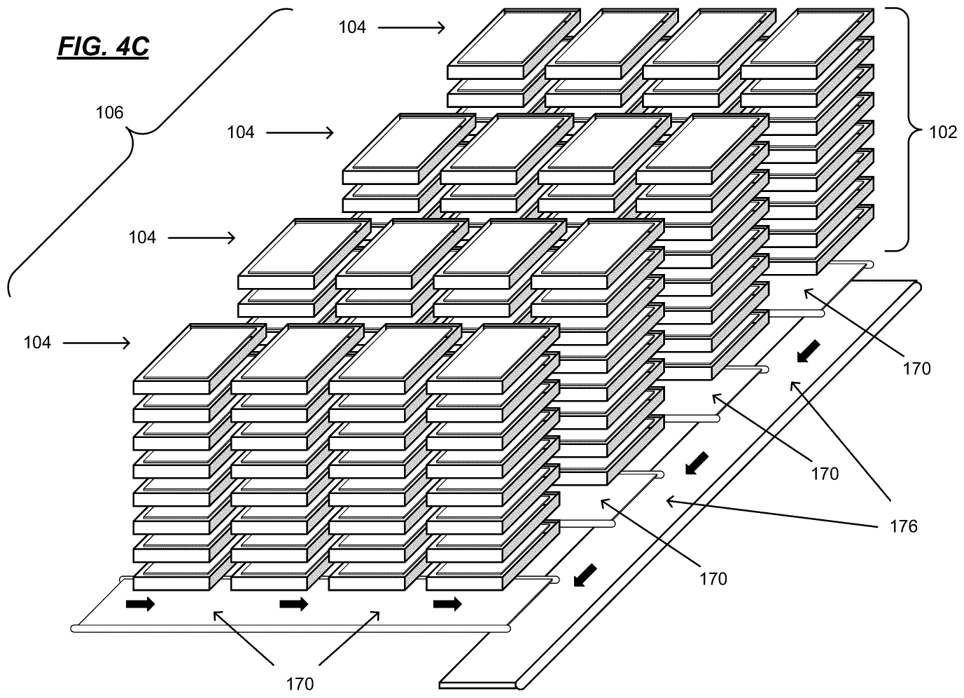

FIG. 4A is an illustration providing a perspective view of a vertical stack 102 of electrolyzer cells 100 representative of various implementations disclosed herein. As shown in FIG. 4A, multiple electrolyzer cells 100 may be vertically orientated over a single conveyor belt 170 (further distinguished in the drawing by the block motion arrow) in order to increase overall capacity, minimize floorspace (or footprint), and increase conveyor belt 170 utilization (and minimize conveyor belt 170 buildout).

FIG. 4B is an illustration providing a perspective view of a lateral line 104 comprising multiple vertical stacks 102 of electrolyzer cells 100 representative of various implementations disclosed herein. As shown in FIG. 4B, multiple stacks may be linearly oriented over a single conveyor belt 170 to further increase overall capacity while again increasing conveyor belt 170 utilization (and minimize conveyor belt 170 buildout) versus the need for individual conveyor belts for each stack 102. Furthermore, for certain implementations, multiple stacks 102 may be oriented on both sides of the conveyor belt 170 to form a duplex line (not shown).

FIG. 4C is an illustration providing a perspective view of a parallel array 106 of multiple lateral lines 104 each comprising multiple stacks 102 of electrolyzer cells 100 representative of various implementations disclosed herein. As shown in FIG. 4C, a plurality of lateral lines 104 and their corresponding conveyor belts may be arranged to form a three-dimensional array 106 of electrolyzer cells that feed into a consolidated cross-conveyor belt 176. Furthermore, for certain implementations, the conveyor belts 170 from multiple lines 104 may be oriented on both sides of the cross-conveyor belt 176 to form a duplex array (not shown). Moreover, the specific height, length, and width of such a parallel array 106 can be configured to optimally fit in almost any three-dimensional space although alternative or additional conveyor belt configurations may be needed.

With regard to all of the various implementations disclosed herein, alternative implementations are also anticipated wherein the horizontal cathode is instead a horizontal anode and the suspended anode is instead a suspended cathode. Moreover, each step of the processes performed by the various implementations herein disclosed may be performed and controlled by a processing unit or other computing environment to include (but in no way limited to) timing of each step of the operation, coordination between different electrolyzer cells, slurry lines, conveyor belts, etc., and variations in time and charge utilized throughout the electrolysis processes, as well as receiving and reacting to feedback from electrical resistance and other detectable occurrences from the electrolysis while in progress.

### Electrolyte and Supplemental Chemicals

As disclosed earlier herein, sodium hydroxide (NaOH)—as well as potassium hydroxide (KOH) and the like—may be used as the electrolyte for subsequent electrolytic processing (e.g., electrolysis) of the lead paste, in which case the resultant lead slurry would be a mixture of the desulfurized lead paste plus the electrolyte (and not a solution thereof in the chemical sense). This approach is a departure from typical electrolytic processing of lead paste dissolved and suspended in an electrolyte solution, noting that typical electrolytic processing has no need of the supplemental chemicals whereas electrolytic processing of a mixture benefits from the supplemental chemicals.

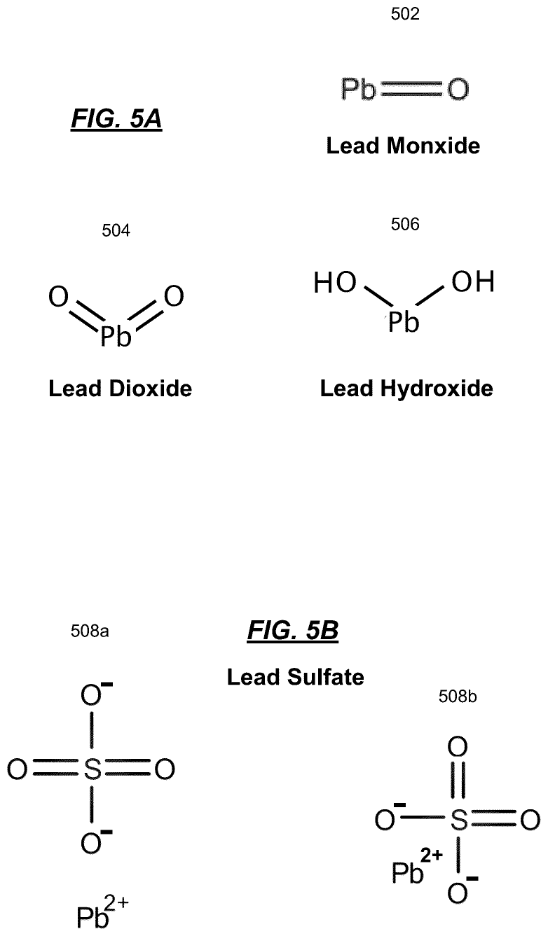

FIG. 5A is an annotated chemical illustration of the respective molecular structures for lead monoxide (PbO) 502, lead dioxide (PbO2) 504, and lead hydroxide (Pb(OH)2) 506 (collectively the “oxidized lead components” or “lead oxides”). FIG. 5B is an annotated chemical illustration of the respective molecular structures for lead sulfate (PbSO4) which, for clarity, is shown with bonding charges 508a and without 508b (that is, with the lead (Pb) atom collocated with the two oxygen atoms having a single bond with the sulfur atom). As previously mentioned, the lead paste derived from LABs during recycling typically comprising portions of pure lead as well as lead monoxide, lead dioxide, and lead sulfate.

Lead monoxide (PbO)—also commonly referred to as lead(II) oxide—has a +2 oxidation state. PbO is formed during discharge of the LAB as a proton-electron mechanism of PbO2 reduction (noting that the positive plate of an LAB is comprised of PbO2 whereas the negative plate of the LAB is comprised of pure lead Pb).

Lead dioxide (PbO2)—also commonly referred to as lead(IV) oxide—has a +4 oxidation state. The positive plate of an LAB is comprised of PbO2 whereas, in contrast, the negative plate of the LAB is comprised of pure lead Pb.

Lead hydroxide (Pb(OH)2)—also commonly referred to as lead(IV) oxide or less precisely as “lead hydrate” (this latter term also used to refer to Pb(H2O)2)—has a +2 oxidation state. Pb(OH)2 results from interactions between the PbO2 plate in an LAB and the aqueous sulfuric acid (H2SO4) solution of the LAB (and also resulting in PbSO4). As described earlier herein, lead sulfate (PbSO4) is converted into lead hydroxide (Pb(OH)2) during desulfurization that occurs before electrolytic processing.

In order for an electrolytic process to successfully recover elemental lead (Pb) from the lead oxides present in the lead slurry prepared for solid-state electrolysis, one or more supplemental chemicals may be added to the lead slurry mixture (comprising the electrolyte and oxidized lead components) prior to electrolytic processing. During electrolysis these supplemental chemicals would effectively enable the oxygen (O) and/or hydroxide (OH) molecules in the lead oxides to disassociate from the lead (Pb) and combine to form gaseous O2 (which may then dissipate out of the mixture and into the surrounding air) and/or aqueous water (H2O) (which may then remain in the mixture and be pressed out or boiled away in subsequent processing of the resultant elemental lead (Pb)).

### Cyclical Recovery of Elemental Lead (Pb) from Dross

During the refining of lead—whether by electrolytic processing (including solid-state electrolysis as disclosed earlier herein), traditional smelting, or other methodology—the melting of near-pure elemental lead (Pb) for casting into ingots (or other casting forms) produces dross that must be removed from the molten elemental lead to maximize its purity. This dross of solid impure components may comprise lead monoxide (PbO) as well as sodium hydroxide (NaOH), sodium sulfate (Na2SO4), barium sulfate (BaSO4), and/or carbon (C) which float as solid components on the surface of the molten elemental lead. In addition, when dross is drawn off of the surface of a molten metal bath, some small portion of elemental lead (Pb) may adhere to the solid components of the dross (somewhat akin to water adhering to the surface of a washed item). Thus drawn-off dross may also include some small amount of pure elemental lead that cools and becomes solid as well.

To recover the elemental lead (Pb) adhering to the dross, any of various tumbling techniques known and appreciated by skilled artisans may be utilized to produce solid elemental lead (Pb) in the form of granules that can be physically separated from the dross and immediately returned to the melter for casting. The remaining dross may then be further processed to recover additional elemental lead (Pb) from the lead monoxide (PbO).

To this end, any of several variations of the electrolytic processes disclosed herein may be further utilized to provide continuous recovery of elemental lead (Pb) from dross by leaching lead monoxide (PbO) from the dross using known solvents—that is, dissolving the lead monoxide from the dross to form a solution—and then filtering out the solid impurities before then reintroducing the lead monoxide (PbO) solution back upstream into the slurry mixer with a subsequent batch of lead paste, electrolyte, and supplemental chemicals to form a follow-on lead slurry for processing in the electrolyzer. In this manner, the lead in dross may be continuously recovered through electrolytic processing (i.e., is “continuous”) with the impurities accompanying the lead in the dross being removed through the leaching of lead monoxide (PbO) into a solution separable from the solid impurities in the dross (“waste”).

Likewise, any of several variations of the electrolytic processes disclosed herein may be further utilized to provide cyclic recovery of elemental lead (Pb) from dross by effectively reintroducing the dross back upstream into the slurry mixer with a subsequent batch of lead paste, electrolyte, and supplemental chemicals to form a follow-on lead slurry for processing in the electrolyzer. In this manner, the lead in dross may be cycled more than once through electrolytic processing (i.e., is “cyclic”), although the impurities accompanying the lead in the dross will also naturally build up with each cycle and thus ostensibly prevent such cyclic processing from being truly continuous; instead, when the impurities in the dross reach a certain point, it may become impractical to further cyclically process the dross through purely electrolytic means, thus becoming waste or material for separate processing (such as by leaching with solvents, etc.). Nevertheless, various implementations disclosed herein are specifically directed to cyclically recovering lead from dross through additional electrolytic processing.

For example, as shown in FIG. 1A, the dross resulting from the melter/caster 32—and specifically from the melter component thereof—may be simply drawn off and passed to a mechanical separator 34 (as shown) to separate elemental lead (Pb) for return to the melter/caster 32 while separately directing the lead monoxide (PbO), in the form of lead dross (which also includes other impurities), back to the slurry mixer 26 for inclusion in the next mix of lead slurry for subsequent processing or, alternately, for separate processing (i.e., dross-only processing). However, because the lead monoxide concentration, as well as non-lead impurities, tend to be higher in dross than in an original processed batch (that is, from unprocessed lead paste derived directly from a recycled LAB), it is necessary for the ratios of electrolyte and supplemental chemicals to be adjusted accordingly. Furthermore, the accumulation of impurities stemming from this cyclic process may eventually reduce system efficiency and effectiveness and thus may effectively preclude further processing of the dross resulting from second, third, or subsequent passes through the cycle (referred to collectively as “secondary dross”). As such, secondary dross eventually becomes waste, that is, it is no longer able to be processed by the system (although such waste may be further processed by other means, for example, leaching lead monoxide using solvents utilizing any of several different techniques known in the art). Therefore, to minimize waste and maximize recovery of elemental lead (Pb) from the lead monoxide (PbO) in dross, various additional implementations herein disclosed attempt to address these inefficiencies.

Accordingly, various implementations disclosed herein are specifically directed to a method and/or system for recovery of near-pure metal from an impure metal-containing dross comprising steps or subsystems for: combining the dross with an electrolyte to form a slurry, said slurry being a mixture of the dross and the electrolyte such that the electrolyte does not dissolve the target metal in the impure metal material; performing electrolysis on the slurry to form target metal deposits and residual components, said electrolysis being performed by an electrolyzer comprising a horizontal cathode having a surface onto which an electrolytic slurry may be emplaced for electrolysis; and separating the target metal in near-pure form from the residual components without smelting. Several such implementations may also further comprise an anode suspended above the horizontal cathode for physically engaging the electrolytic slurry for electrolysis, and/or the addition of at least one supplemental chemical to the slurry prior to performing the electrolysis. Moreover, for several such implementations: the near-pure metal may be elemental lead (Pb) and the dross may comprise at least in part lead monoxide (PbO); the electrolysis may be solid-state electrolysis; the separating may comprise at least in part pressing the target metal; and/or prior to the combining the lead monoxide (PbO) in the dross may be leached into a solution with a solvent.

Select implementations may also be directed to an apparatus for recovery of near-pure metal from an impure metal-containing dross, the apparatus comprising: a horizontal cathode having a surface onto which an electrolytic slurry may be emplaced for electrolysis, the electrolytic slurry comprising the dross combined with an electrolyte to form said slurry, said slurry being a mixture of the dross and the electrolyte such that the electrolyte does not dissolve the target metal in the impure metal material; and an anode suspended above the horizontal cathode for physically engaging the electrolytic slurry for electrolysis. For certain such select implementations: the electrolytic slurry may further comprise at least one supplemental chemical necessary for drawing near-pure metal from the dross; may further comprise a removing mechanism for removing, from the horizontal cathode, an end product resulting from electrolysis; may further comprise a direct current electrical supply and a power controller for controlling a current during electrolysis at one or more levels at one or more time periods during electrolysis; the horizontal anode surface may comprise a plurality of vents through which gaseous compounds resulting from electrolysis can be passed; and/or the near-pure metal may be elemental lead (Pb) and the dross may comprise at least in part lead monoxide (PbO).

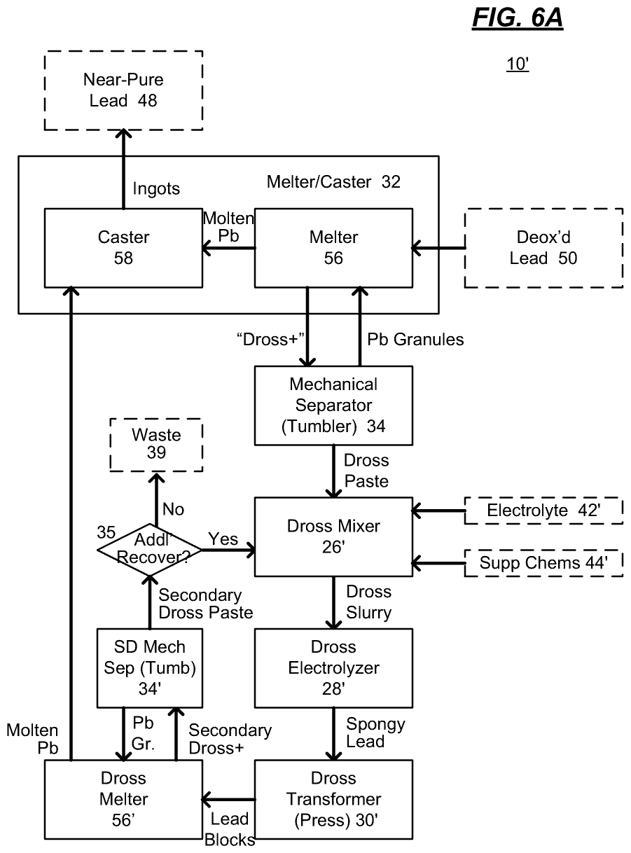

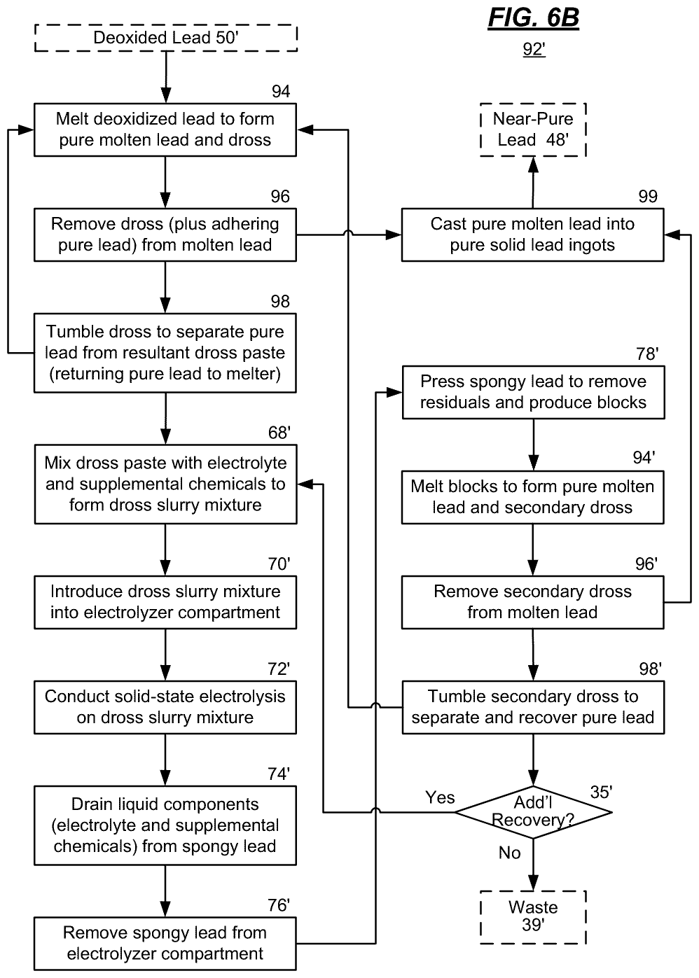

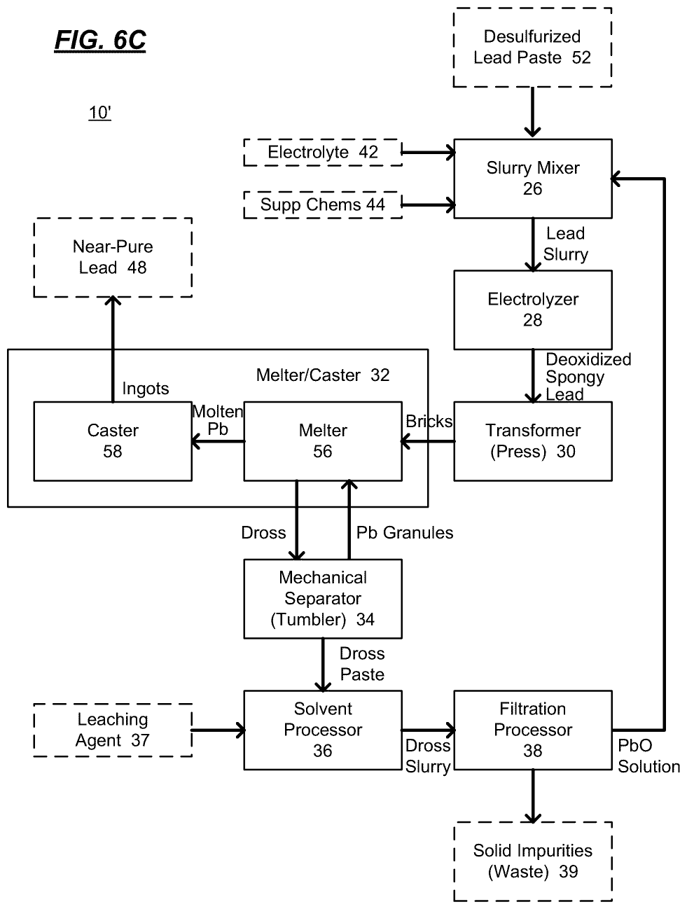

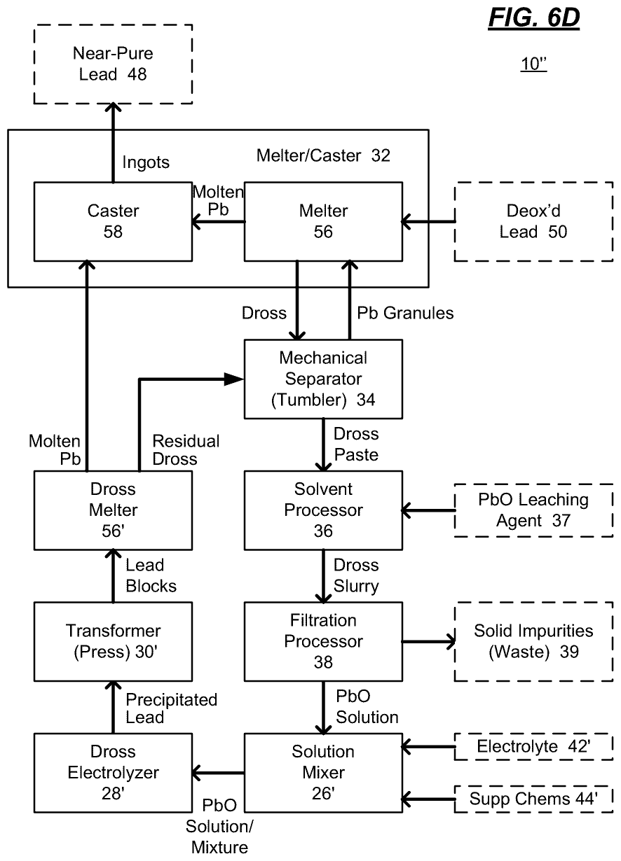

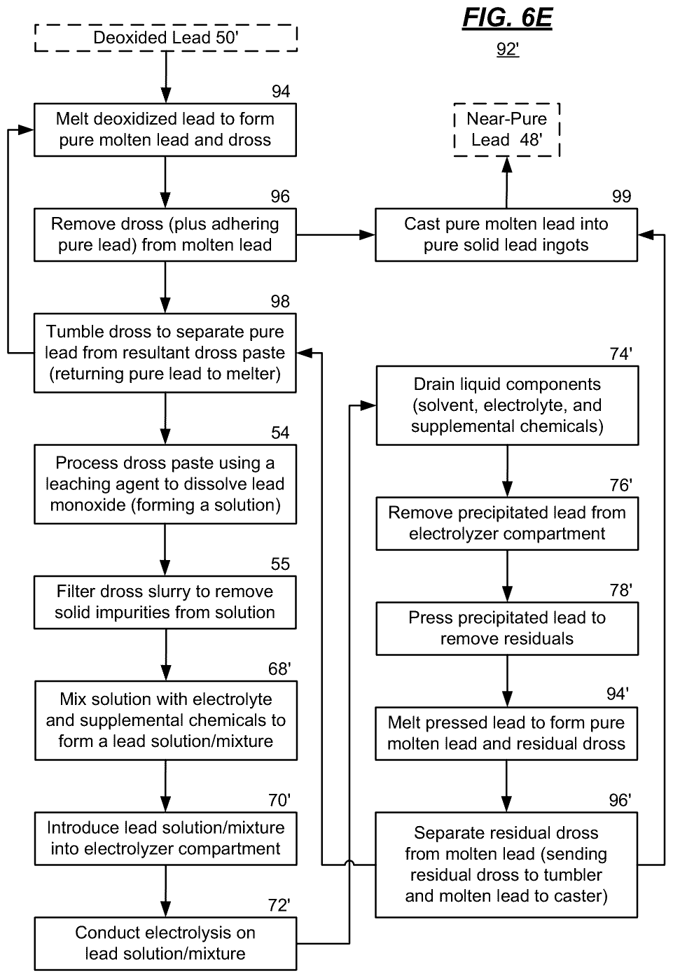

Additionally, FIG. 6A is a partial modified block diagram 10′ illustrating the major components of an exemplary electro-chemical subsystem, based in part on the system 10 illustrated in FIG. 1A, for cyclically reclaiming near-pure lead 48 from dross representative of various implementations disclosed herein. In contrast to the dross processing shown in FIG. 1A—where the dross from the melter/caster 32 is passed to a mechanical separator 34 which returns pure elemental lead (Pb) to the melter/caster 32 while passing lead monoxide (PbO) (along with the other impurities) back to the slurry mixer 26 for further processing and electrolysis by the electrolyzer 28—the subsystem illustrated in FIG. 6A is distinct and separate from upstream processing and thus may process dross from deoxidized lead 50 derived from any source be it electrolytic, smelting, or otherwise.

In FIG. 6A. the subsystem comprises the melter/caster 32 which includes a melter 56 operationally coupled to a caster 58. The melter 56 is also operationally coupled to a series of operationally coupled components comprising a mechanical separator (tumbler) 34, a dross mixer 26′, a dross electrolyzer 28′, a dross transformer (press) 30′, a dross melter 56′, and a secondary dross mechanical separator (tumbler) 34′. The dross melter 56′ is also operationally coupled to the caster 58, while the secondary dross mechanical separator (tumbler) 34′ is operationally coupled to the dross mixer 26′. Also shown in FIG. 6A (as dotted-line inputs or outputs to the subsystem) are deoxidized lead 50, electrolyte 42′, and supplemental chemicals 44′ as subsystem inputs, as well as near-pure lead 48 and waste 39 as subsystem outputs, while other inputs (such as electricity for example) and other outputs (such as reclaimed liquid components from pressing) are not shown as understood, implied, or have been previously disclosed herein.

As shown in FIG. 6A, the melter 56 of this dross processing subsystem may receive deoxidized lead 50 from any of several different sources, including but not limited to smelting, electrolytic processing, or other resource. Applying relatively low heat, the melter 56 then produces both pure molten element lead (Pb) and with solid dross components floating on top. The dross is drawn off, and the caster 58 receives the pure molten elemental lead (Pb) from the melter 56 and outputs ingots of near-pure lead 48. Meanwhile, the mechanical separator 34 receives the dross—comprised of lead monoxide (PbO) and other impurities—and also receives some pure elemental lead that had adhered to the dross when removed from the melter 56 (collectively “dross-plus” or “dross+”). The mechanical separator 34 then “tumbles” the dross+to physically form solid granules of the pure elemental lead and separate them from the remaining dross paste (still comprising lead monoxide (PbO) plus other impurities). The dross mixer 26′ then mixes the dross paste with electrolyte 42′ and supplemental chemicals 44′ to form a dross slurry.

The dross electrolyzer 28′—which may be substantially similar to the electrolyzer 28 disclosed earlier herein—then proceeds to electrolytically process the dross slurry to separate and remove oxygen from lead and effectively convert the lead monoxide (PbO) into elemental lead (Pb) that, together with the other residuals components, comprises spongy lead and residual liquid components, the latter of which is substantially drained away. The dross transformer 30′ then presses the spongy lead to remove any remaining liquid components and forms “blocks” (akin to bricks resulting from transformer 30) that are a mixture of pure lead and impurities, although the pure lead on the surface of said blocks will begin to oxidize (again forming lead monoxide PbO). The dross melter ′56 then melts the lead blocks to separate the liquid pure elemental lead from the floating secondary dross (which includes the newly formed lead monoxide (PbO) and other impurities). The secondary dross mechanical separator 34′ then tumbles the “secondary dross+”—that is, secondary dross plus any pure elemental lead that adhered to the secondary dross during its removal from the dross melter 56′—to produce pure lead granules (for return to the dross melter 56′) and secondary dross paste. A control unit 35, based on a determination of the prospects of further processing the secondary dross, will either return the secondary dross to the dross mixer 26′ for further processing (an additional cycle) or designate the secondary dross as waste (receiving no additional cyclic processing in the subsystem).

Although illustrated as separate components, for certain implementations specific components shown in FIG. 6A may in fact be a single device that is allocated to one purpose at certain times and a second purpose at certain other times. For example, the mechanical separator 34 may also be the same physical device as the secondary dross mechanical separator 34′ when used as such at different times, and the melter 56 may be the same device as the dross melter 56′ when used as such at different times. For certain alternative implementations, such dual-purpose physical components may be utilized for both such purposes at the same time by blending the batches being processed. Regardless, at some point it is expected that the secondary dross produced by the secondary dross mechanical separator 34′ would comprise a high enough ratio of impurities to make further cyclic processing ineffective, although the waste 39 that results might be separately processed to further extract elemental lead from the lead monoxide (PbO) therein.

FIG. 6B is a partial modified process flow diagram 92′ illustrating an exemplary approach for cyclic dross processing, based in part on the approach illustrated in FIG. 1B and FIG. 1C, and utilizing the subsystem illustrated in FIG. 6A, said approach being representative of the various implementations disclosed herein.

In FIG. 6B, at 94 deoxidized lead 50′ is melted to form molten pure elemental lead (Pb) and solid floating dross, the latter of which comprises lead monoxide (PbO) and other impurities. At 96, the dross is removed from the molten lead and the latter, at 99, is cast into pure solid lead ingots that comprise the output of near-pure lead 48′. At 98, the dross—which includes some elemental lead (Pb) that adhered to the dross during its removal from the melter—is tumbled to separate the elemental lead (Pb) from the oxidized lead (PbO) and other impurities which form a dross paste, the elemental lead being returned to the melter for re-melting at 94. At 68′ the dross paste is mixed with electrolyte and supplemental chemicals to form a dross slurry mixture that, at 70′, is introduced into an electrolyzer compartment.

At 72′ the electrolyzer conducts solid-state electrolysis on the dross slurry mixture, effectively removing the oxygen from the lead monoxide (PbO) to produce solid pure elemental lead (Pb) in a spongy form. At ′74 the liquid components are drained from the spongy lead which, at ′76, is then removed from the electrolyzer compartment. At 78′ the spongy lead is pressed to remove any residual liquid components and form lead blocks (akin to bricks). At ′94 the blocks are then melted (that is, re-melted) to form molten pure elemental lead (Pb) separable from solid floating secondary dross, the latter of which is removed at ′96. At ′98 the secondary dross—and the pure elemental lead adhering thereto—are again tumbled to separate the pure elemental lead (Pb) granules from the impure dross with said granules again returned to the melter at 94.

Finally, at 35′ a determination is made (either manually or by some automated logic) as to whether to return the secondary dross to 68′ for additional recovery of lead from the lead monoxide (PbO) in an additional cycle or, if the ratio of impurities is too high for example, to remove the secondary dross from further cyclic processing as waste 39′ (where said waste may still be further processed by separate means to extract additional lead by, for example, leaching with solvents, etc.).

With regard to both FIG. 6A and FIG. 6B, certain alternative implementations may forego or combine certain components and steps respectively but still achieve substantially the same results but at different points in the process. For example, mechanical separator 34 may be eliminated such that the dross+(dross and elemental lead) are mixed, electrolyzed, transformed, and melted as shown such that it is the dross melter 56′ that instead effectively reclaims the pure lead in the dross+. Similarly, the secondary dross+may be directed back to the dross mixer 26′ without tumbling, and the SD mechanical separator 34′ may be utilized only for secondary dross that is designated as waste 39, that is, placing the SD mechanical separator 34′ after control 35 to only recover elemental lead granules for return to the dross melter 56′ for secondary dross that is exiting the otherwise cyclic system as waste 39.

These various implementations may also be utilized in a more general sense for processing any dross that comprises lead monoxide (PbO) where recovery of elemental lead is desired. For example, tin dross—that is, dross drawn from molten tin—may just happen to comprise certain impurities including lead monoxide (PbO) where, given environmental concerns for example, there is a desire to recover the elemental lead (Pb) from the lead monoxide (PbO) therein before otherwise disposing of the tin dross. Accordingly, the various implementations disclosed herein should be understood to apply to any dross comprising in part lead monoxide (PbO).

Moreover, FIG. 6C is a partial modified block diagram 10′ illustrating the major components of an exemplary continuous electro-chemical subsystem, based in part on and further extending the system 10 illustrated in FIG. 1A, for the purpose of reclaiming near-pure lead from dross, said subsystem being representative of various implementations disclosed herein. In addition to the components previously described for FIG. 1A, the subsystem 10′ of FIG. 6C illustrates the melter/caster 32 as comprising two separate components, a melter 56 operationally coupled to a caster 58, the former also being operationally coupled to the mechanical separator (tumbler) 34. The mechanical separator (tumbler) 34 is also operationally coupled to a solvent processor 36 which is operationally coupled to a filtration processor 38 which in turn is operationally coupled to the slurry mixer 26 of FIG. 1A. Also shown in FIG. 6C—as dotted-line inputs or outputs to the subsystem—are electrolyte 42 and supplemental chemicals 44 as system inputs, as well as near-pure lead 48 as a system output (as previously illustrated in FIG. 1A), plus removed solid impurities (waste) 39 as a new subsystem output. Other inputs (such as electricity for example) and other outputs (such as reclaimed liquid components from pressing for example) are not shown but will be implied or understood by skilled artisans and/or already previously disclosed, implied, or suggested earlier herein.

As shown in FIG. 6C, the dross resulting from the melter 56 may be drawn off and passed to the mechanical separator 34 for physical “tumbling,” a process known and appreciated by skilled artisans which separates from the dross the elemental lead (Pb), in the form of granules, for return to the melter 56 while separately directing the lead monoxide (PbO), in the form of lead dross (which also includes other impurities), to the solvent processor 36. The solvent processor 36, using any of several leaching agents 37 known in the art, adds the solvent to the lead dross to dissolve the lead monoxide (PbO) creating a dross solution comprising dissolved lead dioxide (PbO) plus the still-solid impurities. This dross solution then may be filtered by the filtration processor 38—which may be part of the solution processor 36 or separate therefrom—to remove the solid impurities (waste) 39 from the lead dioxide solution, the latter of which can then be redirected back to the slurry mixer 26 for subsequent re-processing thereby and by the electrolyzer 28, transformer 30, and melter/caster 32.

Because solid impurities are removed by the filtration processor 38 and liquid impurities are mostly removed by the transformer (press) 30 and melter 56, the process represented by this subsystem 10′ can be operated continuously with PbO solution being reprocessed alone (or as a group of PbO solutions resulting from several serial processes) or mixed in the slurry mixer 26 with a subsequent batch of lead paste, e.g., new “original” lead paste derived from recycled LABs. Regardless, because the lead monoxide concentration will be higher in subsequent processing than a new/original processed batch (that is, from unprocessed lead paste derived directly from a recycled LAB), it may be necessary for the ratios of electrolyte and supplemental chemicals to be adjusted accordingly when a lead monoxide (PbO) solution is added to the slurry mixer. Regardless, the subsystem of FIG. 6C is integrated into a larger system that leverages the same electrolytic processing for both new/original processing of a lead slurry mixture and for the subsequent processing of a lead monoxide (PbO) solution.

In contrast, alternative implementations disclosed herein are directed to similar subsystems for processing lead dross regardless of the source of such dross, be it from smelting, electrolytic processing, or other processes.

FIG. 6D is a partial modified block diagram 10″ illustrating the major components of an exemplary electro-chemical subsystem, based in part on the system 10 illustrated in FIG. 1A, but for continuously reclaiming near-pure lead 48 from lead dross derived from any source of deoxidized lead 50 (not just electrolytic processing sources as shown in FIG. 6C), said subsystem representative of various implementations disclosed herein. As illustrated in FIG. 6D, the subsystem comprises the melter/caster 32 which further includes a melter 56 operationally coupled to a caster 58. The melter 56 is also operationally coupled to a series of operationally coupled components comprising a mechanical separator (tumbler) 34, a solvent processor 36, a filtration processor 38, a solution mixer 26′, a dross electrolyzer 28′, a dross transformer (press) 30′, and a dross melter 56′. The dross melter 56′ is operationally coupled to the caster 58 and the mechanical separator (tumbler) 34. Also shown in FIG. 6D (as dotted-line inputs or outputs to the subsystem) are deoxidized lead 50, lead monoxide (PbO) leaching agent (solvent) 37, electrolyte 42′, supplemental chemicals 44′ as subsystem inputs, as well as near-pure lead 48 and solid impurities (waste) 39 as subsystem outputs, while other inputs (such as electricity for example) and other outputs (such as reclaimed liquid components from pressing for example) are not shown but will be understood as included or implied by skilled artisans or have been previously disclosed herein.

As shown in FIG. 6D, the melter 56 of this dross processing subsystem may receive deoxidized lead 50 from any of several different sources, including but not limited to smelting, electrolytic processing, or other sources. Applying relatively low heat, the melter 56 then produces both pure molten element lead (Pb) with solid dross components floating on top. This dross is drawn off and the caster 58 receives the pure molten elemental lead (Pb) from the melter 56 and outputs ingots of near-pure lead 48. Meanwhile, the mechanical separator 34 receives the dross—comprised of lead monoxide (PbO) and other impurities—and also receives some pure elemental lead that may have adhered to the dross when removed from the melter 56. The mechanical separator 34 then “tumbles” the dross to physically form solid granules of the pure elemental lead and separate them from the remaining dross paste, the latter still comprising lead monoxide (PbO) plus other impurities. The solvent processor 36 then dissolves the lead monoxide (PbO) in the dross paste to form a lead monoxide (PbO) solution plus solid impurities that together comprise a dross slurry. The dross slurry is then filtered by the filtration processor 38 to separate (and dispose of) the solid impurities (waste) 39 from the lead monoxide (PbO) solution with the latter then mixed with electrolyte 42′ and supplemental chemicals 44′ in the solution mixer 26′. The resultant lead monoxide (PbO) solution/mixture is then processed by the dross electrolyzer 28′—which may be substantially similar to the electrolyzer 28 disclosed earlier herein, or it may be of a more traditional electrolysis-type design—to separate and remove oxygen from lead and effectively convert the lead monoxide (PbO) into elemental lead (Pb) that precipitates from the solvent, the latter of which along with the other liquid components being substantially drained away. The dross transformer 30′ then presses the precipitated lead to remove any remaining liquid components and forms lead “blocks” (akin to bricks resulting from transformer 30 of FIG. 1A) that are pure elemental lead, although the pure lead on the surface of said blocks will begin to oxidize (again forming lead monoxide PbO). The dross melter ′56 then melts the lead blocks to separate the liquid pure elemental lead from the oxidized lead which forms a floating residual dross (comprising the newly formed lead monoxide (PbO) which is directed back to the mechanical separator 34′ for reprocessing, either alone, in collected groups of residual dross, or in combination with new dross received from melter 56.

Because solid impurities are removed by the filtration processor 38 and liquid impurities are mostly removed by the transformer (press) 30 and melter 56, the process represented by this subsystem 10″ can be operated continuously with residual dross being reprocessed alone (or as a group of PbO solutions resulting from several serial processes) or combined in the mechanical separator 34 with a subsequent batch of dross. Regardless, because the lead monoxide concentration may be higher in subsequent processing than a new/original processed batch (that is, from unprocessed lead paste derived directly from a recycled LAB), it may be necessary for the ratios of electrolyte and supplemental chemicals to be adjusted accordingly when a lead monoxide (PbO) solution is added to the solution mixer 26′. Regardless, the subsystem of FIG. 6D may effectively leverage the same electrolytic processing of FIG. 1A for a lead slurry mixture here for the processing of a lead monoxide (PbO) solution/mixture.

Although illustrated as separate components, for certain implementations specific components shown in FIG. 6C and/or FIG. 6D may in fact be a single device that is allocated to one purpose at certain times and a second purpose at certain other times. For example, the melter 56 may be the same device as the dross melter 56′ when used at different times. For certain alternative implementations, such dual-purpose physical components may be utilized for both such purposes at the same time by blending their batches being processed and would continue to support continuous processing.

FIG. 6E is a partial modified process flow diagram 92″ illustrating an exemplary approach for continuous dross processing, based in part on the approach illustrated in FIG. 1B and FIG. 1C, but utilizing the subsystem 10″ illustrated in FIG. 6D representative of various implementations disclosed herein.

In FIG. 6E, at 94 deoxidized lead 50′ is melted to form molten pure elemental lead (Pb) and solid floating dross, the latter of which comprises lead monoxide (PbO) and other impurities. At 96, the dross is removed from the molten lead and the latter, at 99, is cast into pure solid lead ingots that comprise the output of near-pure lead 48′. At 98, the dross—which includes some elemental lead (Pb) that adhered to the dross during its removal from the melter—is tumbled to separate the elemental lead (Pb) from the oxidized lead (PbO) and other impurities which form a dross paste, the elemental lead being returned to the melter for re-melting at 94. At 54 the dross paste is combined with a leaching agent (solvent) to dissolve the lead monoxide (PbO) and form a solution thereof in order to effectively separate the lead monoxide (PbO) from the solid impurities at 55 with said solid impurities (waste) 39 being filtered out. At 68′ the lead monoxide (PbO) solution is then mixed with electrolyte and supplemental chemicals to form a lead monoxide (PbO) solution/mixture that, at 70′, is introduced into the electrolyzer compartment.

At 72′ electrolysis (solid-state and/or traditional solution-based) is conducted on the lead solution/mixture—causing the oxygen to disassociate from the lead and escape into the atmosphere, and the resulting pure lead precipitating out of the solution—and the liquid components (solvent, electrolyte, and supplemental chemicals) are drained at 74′. At 76′ the precipitated lead is then removed from the electrolyzer compartment and, at ′78, pressed to remove any residual components. At 94′ the pressed pure elemental lead (Pb), which may have some surface oxidation and retained some small measure of impurities, is then melted to form pure molten elemental lead (Pb) and residual dross, the latter of which is separated from the pure molten elemental lead (Pb) and sent back to the tumbling at 98, while the pure molten elemental lead (Pb) is cast into pure solid lead ingots at 99 marking the end of the process with output of near-pure lead 48′ (in ingot form).

With regard to FIG. 6C, FIG. 6D, and FIG. 6E, certain alternative implementations may forego or combine certain components and steps respectively but still achieve substantially the same results but at different points in the process. For example, mechanical separator 34 may be eliminated such that the dross is mixed, electrolyzed, transformed, and melted as shown, and it is dross melter 56′ that instead effectively reclaims the pure lead that adhered to the dross when drawn from the melter 56. Similarly, the residual dross may be directed back to the solvent processor 36 without tumbling, and the mechanical separator 34 may be utilized only after filtration processing 38 to recover any elemental lead in the solid impurities (waste) 39 before being removed entirely from the subsystem processing, and with any recovered elemental lead granules being returned to the dross melter 56′ or even to the melter 56. These and other variations will be readily apparent to skilled artisans.

These various implementations may also be utilized in a more general sense for processing any dross that comprises lead monoxide (PbO) where recovery of elemental lead is desired. For example, tin dross—that is, dross drawn from molten tin—may just happen to comprise certain impurities including lead monoxide (PbO) where, given environmental concerns for example, there is a desire to recover the elemental lead (Pb) from the lead monoxide (PbO) therein before otherwise disposing of the tin dross. Accordingly, the various implementations disclosed herein should be understood to apply to any dross comprising in part lead monoxide (PbO).

With regard to the foregoing disclosures and references to leaching and solvents—and as known and appreciated by skilled artisans—lead monoxide (PbO) can be removed from dross by the utilization of sodium hydroxide (NaOH) which acts to dissolve the lead monoxide (PbO) and forms a solution that is effectively separate from the other solid impurities comprising the dross. Once the dissolved lead-containing solution is separated from the solid dross remnants—that is, after the solid remnants are filtered from the solution—the lead monoxide (PbO) solution can be further processed to recover pure lead (Pb) therefrom. Accordingly, sodium hydroxide (NaOH) is one of several possible leaching agents available for dissolving the lead monoxide (PbO) found in dross.

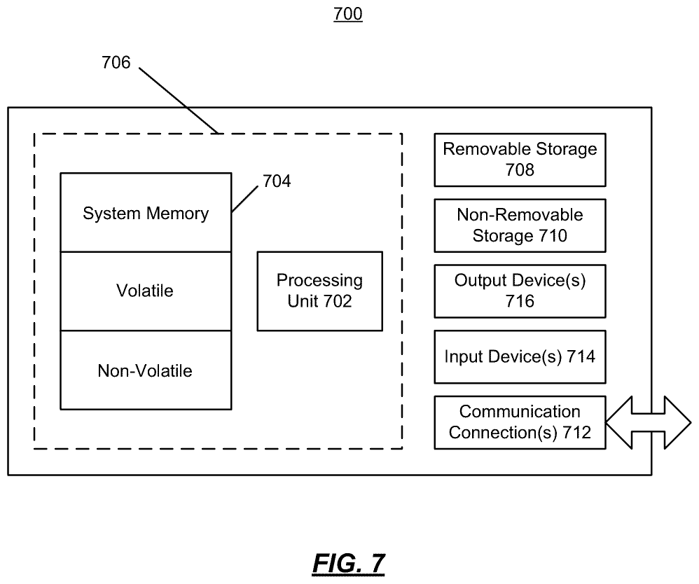

FIG. 7 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 7, an exemplary system for implementing aspects described herein includes a computing device, such as computing device 700. In a basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This basic configuration is illustrated in FIG. 7 by dashed line 706 and may be referred to collectively as the “compute” component.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710. Computing device 700 typically includes a variety of computer readable media. Computer readable media can be any available media that can be accessed by device 700 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules, or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, and so forth. Output device(s) 716 such as a display, speakers, printer, and so forth may also be included. All these devices are well-known in the art and need not be discussed at length herein. Computing device 700 may be one of a plurality of computing devices 700 inter-connected by a network. As may be appreciated, the network may be any appropriate network, each computing device 700 may be connected thereto by way of communication connection(s) 712 in any appropriate manner, and each computing device 700 may communicate with one or more of the other computing devices 700 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

### Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. As one example, the controller service may be accessed by a mobile device. As another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

### Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth—such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### Copyright Notice

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A method for recovery of near-pure metal from an impure metal-containing dross, the method comprising:
combining the dross with an electrolyte to form a slurry, said slurry being a mixture of the dross and the electrolyte such that the electrolyte does not dissolve the target metal in the impure metal material;
performing electrolysis on the slurry to form target metal deposits and residual components, said electrolysis being performed by an electrolyzer comprising a horizontal cathode having a surface onto which an electrolytic slurry may be emplaced for electrolysis; and
separating the target metal in near-pure form from the residual components without smelting.

2. The method of claim 1, wherein the electrolyzer further comprises an anode suspended above the horizontal cathode for physically engaging the electrolytic slurry for electrolysis.

3. The method of claim 1, further comprising adding at least one supplemental chemical to the slurry prior to performing the electrolysis.

4. The method of claim 3, wherein the near-pure metal is elemental lead (Pb) and the dross comprises at least in part lead monoxide (PbO).

5. The method of claim 4, wherein the electrolysis is solid-state electrolysis.

6. The method of claim 5, wherein the separating comprises at least in part pressing the target metal.

7. The method of claim 4, wherein prior to the combining the lead monoxide (PbO) in the dross is leached into a solution with a solvent.

8. A system for recovery of near-pure metal from an impure metal-containing dross, the system comprising at least one subsystem for:
combining the dross with an electrolyte to form a slurry, said slurry being a mixture of the dross and the electrolyte such that the electrolyte does not dissolve the target metal in the impure metal material;
performing electrolysis on the slurry to form target metal deposits and residual components, said electrolysis being performed by an electrolyzer comprising a horizontal cathode having a surface onto which an electrolytic slurry may be emplaced for electrolysis; and
separating the target metal in near-pure form from the residual components without smelting.

9. The system of claim 8, wherein the electrolyzer further comprises an anode suspended above the horizontal cathode for physically engaging the electrolytic slurry for electrolysis.

10. The system of claim 8, further comprising at least one subsystem for adding at least one supplemental chemical to the slurry prior to performing the electrolysis.

11. The system of claim 10, wherein the near-pure metal is elemental lead (Pb) and the dross comprises at least in part lead monoxide (PbO).

12. The system of claim 11, wherein the electrolysis is solid-state electrolysis.

13. The system of claim 12, wherein the separating comprises at least in part pressing the target metal.

14. The system of claim 11, wherein prior to the combining the lead monoxide (PbO) in the dross is leached into a solution with a solvent.

15. An apparatus for recovery of near-pure metal from an impure metal-containing dross, the apparatus comprising:
a horizontal cathode having a surface onto which an electrolytic slurry may be emplaced for electrolysis, the electrolytic slurry comprising the dross combined with an electrolyte to form said slurry, said slurry being a mixture of the dross and the electrolyte such that the electrolyte does not dissolve the target metal in the impure metal material; and
an anode suspended above the horizontal cathode for physically engaging the electrolytic slurry for electrolysis.

16. The apparatus of claim 15, wherein the electrolytic slurry further comprises at least one supplemental chemical necessary for drawing near-pure metal from the dross.

17. The apparatus of claim 15, further comprising a removing mechanism for removing, from the horizontal cathode, an end product resulting from electrolysis.

18. The apparatus of claim 15, wherein the horizontal anode surface comprises a plurality of vents through which gaseous compounds resulting from electrolysis can be passed.

19. The apparatus of claim 15, further comprising a direct current electrical supply and a power controller for controlling a current during electrolysis at one or more levels at one or more time periods during electrolysis.

20. The apparatus of claim 15, wherein the near pure metal is elemental lead (Pb) and the dross comprises at least in part lead monoxide (PbO).
